(19) United States
(12) Patent Application Publication
(10) Pub. No.: US 2011/0105323 A1
(43) Pub. Date: May 5, 2011

(54) Calcium Salts of Phosphorous Acid for Increasing the Effect of Fungicides

(75) Inventors: Karl-Heinrich Schneider, Kleinkarlbach (DE); Erich Birner, Altleiningen (DE); Michael Merk, Arese (IT); John-Bryan Speakman, Bobenheim (DE); Randall Evan Gold, Obrigheim (DE); Maria Scherer, Landau (DE)

(73) Assignee: BASF SE, LUDWIGSHAFEN (DE)

(21) Appl. No.: 12/997,084

(22) PCT Filed: Jun. 2, 2009
(86) PCT No.: PCT/EP09/56713

§ 371 Date: Dec. 9, 2010

(30) Foreign Application Priority Data
Jun. 12, 2008 (EP) 08158136.5

(51) Int. Cl. A01C 1/06; A01N 59/26; A01P 3/00; C01B 25/163

(52) U.S. Cl. 504/100; 424/602; 423/307

(57) ABSTRACT

The present invention relates to the use of calcium salts of phosphorous acid for increasing the efficacy of fungicides in agriculture. Moreover, the invention relates to solid formulations, to processes for preparing the solid formulations and to their use for controlling harmful fungi. Furthermore, the invention relates to a process for preparing a calcium salt of phosphorous acid.

The present invention relates to the use of calcium salts of phosphorous acid for increasing the efficacy of fungicides in agriculture. Moreover, the invention relates to solid formulations, to processes for preparing the solid formulations and to their use for controlling harmful fungi. Furthermore, the invention relates to a process for preparing a calcium salt of phosphorous acid.

In agriculture, it has been known for a long time that phosphorous acid and its alkali metal and alkaline earth metal salts and esters increase the efficacy of fungicides. U.S. Pat. No. 4,075,324 describes a fungicidal composition based on phosphorous acid or its salts which demonstrates the general fungicidal activity of phosphites. In combination with fungicides, they are only said to have additive activity. A wettable powder of secondary calcium phosphite (CaHPO₃) is mentioned in the examples. U.S. Pat. No. 5,626,281 discloses the preparation of fungicidal compositions as water-soluble granules using phosphites in solid or solidified form. WO 2002/05650 discloses fungicidal preparations comprising derivatives and salts of phosphorous acid in combination with organic compounds consisting of at least one amino acid and at least one algae extract. WO 2004/047540 describes a particularly strong synergistic effect of potassium phosphite on certain synthetic fungicides. WO 2006/128677 discloses fungicidal compositions comprising copper(II) salts of phosphorous acid, a further metallic salt of phosphorous acid and a fungicide. WO 2007/017220 describes synergistic mixtures of salts of phosphorous acid and a compound having no or little fungicidal activity and intrinsic photocatalytical properties.

However, the formulation options for the derivatives of phosphorous acid described are limited, and under certain conditions their efficacy, too, is unsatisfactory. In particular in the preparation of solid crop protection formulations such as water-dispersible powders (WP) or water-dispersible granules (WG), the derivatives described do not afford any products suitable for application.

In the preparation of water-dispersible powders, active compounds or active compound mixtures are mixed with formulation auxiliaries and then ground in jet mills or mechanical mills, such as, for example, hammer mills or pin mills. Both before and after grinding, the powders have to be sufficiently flowable so that a satisfactory product quality can be achieved. During the mixing and grinding process, when the customary potassium and/or sodium salts of phosphorous acid are used, heavy agglomerations are formed owing to their high hygroscopicity, making processing impossible.

In the preparation of water-dispersible granules by spray drying or fluidized bed granulation processes, initially aqueous solutions or ground suspensions of active compounds or active compound mixtures with various formulation auxiliaries are produced, which are then, after spraying in the form of small droplets, dried by convective input of heat. Rapid drying of the droplets at the process temperatures possible is necessary to achieve satisfactory granulation. When the customary potassium and/or sodium salts of phosphorous acid are used, the production of granules is impossible even at high temperatures. Even drying under reduced pressure does not afford any dry products.

In the preparation of water-dispersible granules by extruder granulation processes, initially pulverulent ground premixes of active compounds or active compound mixtures with various formulation auxiliaries are prepared and then moistened with water and kneaded, extruded as cylinder-shaped granules using an extruder (for example a basket extruder or a radial extruder) and then dried by convective input of heat. When the customary potassium and/or sodium salts of phosphorous acid are used, it is no longer possible to remove the added water in the drying step, and the preparation of stable granules is impossible.

Owing to their hygroscopicity, potassium phosphite and sodium phosphite can only be processed in aqueous formulations. Other types of formulation, in particular solid formulations, such as, for example, water-dispersible granules (WG) or water-dispersible powders (WP) are excluded. Hitherto, in practice, only liquid formulations of phosphorous acid based on the potassium and/or sodium salts of phosphorous acid have been used. Owing to their high hygroscopicity, these salts cannot be formulated satisfactorily in solid form. On the other hand, certain active compounds, for example dithiocarbamates, are, for chemical reasons, not permanently stable in liquid formulation. If such active compounds are to be formulated in combination with the synergist, only solid formulations are possible. However, such solid formulations can not be prepared stably with the known sodium and potassium phosphites.

It was an object of the present invention to provide a potent synergist for fungicides in crop protection which is easy to formulate and broadly applicable, and also solid formulations based on phosphorous acid and, if appropriate, further fungicidally active compounds, where the handling and the storage stability of the formulations is significantly improved compared to known formulations.

This object was achieved by using calcium salts of phosphorous acid for increasing the efficacy of fungicides in agriculture. The calcium salts of phosphorous acid are preferably in the form of a solid formulation. They are particularly preferably in the form of granules.

According to the invention, calcium salts of phosphorous acid are used for increasing the efficacy of a fungicide in agriculture. In general, it is possible to increase the efficacy of one or more, such as two or three, fungicides at the same time. Preferably, the calcium salts of phosphorous acid are used for increasing the efficacy of a fungicide which is an organic synthetic compound. Organic synthetic fungicides are usually constructed of carbon and hydrogen and may furthermore comprise heteroatoms, such as oxygen, nitrogen, sulfur, halogens and/or phosphorus. Such fungicides are prepared from chemicals in a targeted manner by chemical conversion.

The fungicide is furthermore preferably essentially free of copper salts. Copper salts, such as salts comprising Cu⁺ or Cu²⁺, are compounds known per se having a known fungicidal action. However, the application of copper salts to areas used for agriculture has ecological disadvantages. The term “essentially free” usually means less than 3% by weight, preferably less than 1% by weight, particularly preferably less than 0.1% by weight, based on the total amount of fungicide.

The calcium salts of phosphorous acid are used for increasing the efficacy of a fungicide in agriculture.

“Increasing the efficacy of a fungicide” is to be understood as meaning that, in combination with a calcium salt of phosphorous acid, the activity is increased in a synergistic manner. Furthermore, in many cases, the activity spectrum can be broadened, or the development of resistance can be prevented.

“Phosphorous acid” is to be understood as meaning both phosphorous acid having the formula P(OH)₃ and the tautomeric phosphonic acid HP(O)(OH)₂. “Salts of phosphorous acid” are to be understood as meaning both salts of phosphorous acid and salts of the tautomeric phosphonic acid. The inorganic salts of phosphorous acid are usually referred to as phosphite (or phosphonate; empirical formula [HPO₃]²⁻) or hydrogenphosphite (or hydrogenphosphonate; empirical formula [H₂PO₃]⁻). Hereinbelow, the salts of phosphorous acid are also referred to as phosphites.

Suitable calcium salts of phosphorous acid are, for example, calcium phosphite CaHPO₃ or calcium hydrogenphosphite Ca(H₂PO₃)₂. Preference is given to calcium hydrogenphosphite. In a preferred embodiment, the molar ratio of calcium to phosphorus in calcium hydrogenphosphite is from 1:2.1 to 1:1.8, in particular from 1:2.05 to 1:1.9.

The calcium salts of phosphorous acid may comprise water of crystallization. Preferably, they comprise water of crystallization, in particular in a molar ratio of Ca:H₂O of from 0.5:3 to 3:0.5, especially from 0.8:2 to 2:0.8. In one embodiment, preference is given to calcium phosphite having one mol of water of crystallization per Ca (CaHPO₃*1H₂O). In general, as a 1% by weight aqueous solution, it has a pH of from 2 to 6, preferably from 3 to 5. In a further embodiment, preference is given to calcium hydrogenphosphite having one mol of water of crystallization per Ca (Ca(H₂PO₃)₂*1H₂O). The especially preferred calcium salt of phosphorous acid is Ca(H₂PO₃)₂*1H₂O.

Calcium salts of phosphorous acid are known in a general manner from the literature. The preparation is described, inter alia, in U.S. Pat. No. 4,075,324. Here, calcium hydrogenphosphite is prepared from calcium carbonate and phosphorous acid, or calcium phosphite is prepared from calcium chloride and ammonium phosphite. Dlouhý, Ebert and Vesely (Collection of Czechoslovak Chemical Communications, 1959, 2, 2801-2802) describe the preparation of calcium hydrogenphosphite starting with phosphorous acid and solid carbonate or hydroxide. Unreacted phosphorous acid has to be removed using an excess of ethanol.

We have found a particularly advantageous process according to the invention for preparing a calcium salt of phosphorous acid where an aqueous suspension of calcium hydroxide Ca(OH)₂ and/or calcium oxide CaO is reacted with phosphorous acid H₃PO₃ and water. The process is suitable in particular for preparing calcium hydrogenphosphite. The phosphorous acid is preferably present as an aqueous solution. The reaction can be carried out, for example, by introducing a 20% by weight strength calcium hydroxide suspension into a 50% strength H₃PO₃ solution, or else vice versa. A further variant is the introduction of solid H₃PO₃ into a 20% strength calcium hydroxide suspension.

In general, phosphorous acid H₃PO₃ and water are added with input of energy to the suspension of calcium hydroxide Ca(OH)₂ and/or calcium oxide CaO. The reaction can be carried out in a temperature range of 20-100° C. By adjusting the rate of addition and the dissipation of the heat of neutralization, the reaction temperature can be controlled as desired. Depending on the temperature, the degree of neutralization and the concentration, the calcium salt of phosphorous acid formed is present in dissolved and/or suspended form.

The resulting aqueous suspension of the calcium salt of phosphorous acid can be dried by customary processes, for example by evaporation under reduced pressure in a paddle dryer, by freeze drying, by spray drying and by drum drying. In a further preferred embodiment, the suspension is used without drying in the process according to the invention for preparing the solid formulation.

To prepare calcium hydrogenphosphite, usually 1 mol of finely divided aqueous calcium hydroxide suspension is added to 2 mol of phosphorous acid. The pH of the 1% by weight strength aqueous solution is in the range of from 2.0 to 6.0, preferably from 3.0 to 5.0. If drying is carried out below 100° C., what is obtained is usually solid calcium hydrogenphosphite comprising one mol of water of crystallization (residual water content about 8%). Preferably, the suspension of calcium hydrogenphosphite is only dried to the point where one mol of water of crystallization per Ca remains in the calcium hydrogenphospite.

To prepare calcium phosphite, usually 1 mol of aqueous calcium hydroxide suspension is added to 1 mol of phosphorous acid. The pH of the 1% by weight strength aqueous solution is in the range of from 6 to 12, preferably from 7 to 10.

The process according to the invention for preparing a calcium salt of phosphorous acid has the advantages of a high conversion combined with a short reaction time, fast adjustment of the pH of the aqueous solution and low generation of heat. An additional purification step, such as the extraction of unreacted phosphorous acid with ethanol, is not required.

The term “pesticide” or “crop protection agent” means that one or more compounds can be selected from the group of the fungicides, insecticides, nematicides, herbicides, safeners and growth regulators. It is also possible to use mixtures of two or more of the classes mentioned above. The person skilled in the art is familiar with such pesticides, which may be found, for example, in the “Pesticide Manual”, 13th Ed. (2003), The British Crop Protection Council, London.

Listed below are fungicides which can be used together with calcium salts of phosphorous acid. The list is intended to illustrate possible combinations, but not to limit them. These fungicides are preferably used together with calcium salts of phosphorous acid.

A) strobilurins:
azoxystrobin, dimoxystrobin, enestroburin, fluoxastrobin, kresoxim-methyl, metominostrobin, orysastrobin, picoxystrobin, pyraclostrobin, pyribencarb, trifloxystrobin, 2-(2-(6-(3-chloro-2-methylphenoxy)-5-fluoropyrimidin-4-yloxy)phenyl)-2-methoxyimino-N-methylacetamide, methyl 2-(ortho-((2,5-dimethylphenyloxymethylene)phenyl)-3-methoxyacrylate, methyl 3-methoxy-2-(2-(N-(4-methoxyphenyl)-cyclopropanecarboximidoylsulfanylmethyl)phenyl)acrylate, 2-(2-(3-(2,6-dichloro-phenyl)-1-methylallylideneaminooxymethyl)phenyl)-2-methoxyimino-N-methyl-acetamide;

B) carboxamides:
carboxanilides: benalaxyl, benalaxyl-M, benodanil, bixafen, boscalid, carboxin, fenfuram, fenhexamid, flutolanil, furametpyr, isopyrazam, isotianil, kiralaxyl, mepronil, metalaxyl, metalaxyl-M, ofurace, oxadixyl, oxycarboxin, penthiopyrad, tecloftalam, thifluzamide, tiadinil, 2-amino-4-methylthiazole-5-carboxanilide, 2-chloro-N-(1,1,3-trimethylindan-4-yl)nicotinamide, N-(2′,4′-difluorobiphenyl-2-yl)-3-difluoromethyl-1-methyl-1H-pyrazole-4-carboxamide, N-(2′,4′-dichlorobiphenyl-2-yl)-3-difluoromethyl-1-methyl-1H-pyrazole-4-carboxamide, N-(2′,5′-difluorobiphenyl-2-yl)-3-difluoromethyl-1-methyl-1H-pyrazole-4-carboxamide, N-(2′,5′-dichlorobiphenyl-2-yl)-3-difluoromethyl-1-methyl-1H-pyrazole-4-carboxamide, N-(3′,5′-difluorobiphenyl-2-yl)-3-difluoromethyl-1-methyl-1H-pyrazole-4-carboxamide, N-(3′,5′-dichlorobiphenyl-2-yl)-3-difluoromethyl-1-methyl-1H-pyrazole-4-carboxamide, N-(3′-fluorobiphenyl-2-yl)-3-difluoromethyl-1-methyl-1H-pyrazole-4-carboxamide, N-(3′-chlorobiphenyl-2-yl)-3-difluoromethyl-1-methyl-1H-pyrazole-4-carboxamide, N-(2′-fluorobiphenyl-2-yl)-3-difluoromethyl-1-methyl-1H-pyrazole-4-carboxamide, N-(2′-chlorobiphenyl-2-yl)-3-difluoromethyl-1-methyl-1H-pyrazole-4-carboxamide, N-(3′,4′,5′-trifluorobiphenyl-2-yl)-3-difluoromethyl-1-methyl-1H-pyrazole-4-carboxamide, N-(2′,4′,5′-trifluorobiphenyl-2-yl)-3-difluoromethyl-1-methyl-1H-pyrazole-4-carboxamide, N-[2-(1,1,2,3,3,3-hexafluoropropoxy)phenyl]-3-difluoromethyl-1-methyl-1H-pyrazole-4-carboxamide, N-[2-(1,1,2,2-tetrafluoroethoxy)phenyl]-3-difluoromethyl-1-methyl-1H-pyrazole-4-carboxamide, N-(4′-trifluoromethylthiobiphenyl-2-yl)-3-difluoromethyl-1-methyl-1H-pyrazole-4-carboxamide, N-(3′,4′-dichloro-5-fluorobiphenyl-2-yl)-3-difluoromethyl-1-methyl-1H-pyrazole-4-carboxamide, N-(2-(1,3-dimethylbutyl)phenyl)-1,3,3-trimethyl-5-fluoro-1H-pyrazole-4-carboxamide, N-(4′-chloro-3′,5′-difluorobiphenyl-2-yl)-3-difluoromethyl-1-methyl-1H-pyrazole-4-carboxamide, N-(4′-chloro-3′,5′-difluorobiphenyl-2-yl)-3-trifluoromethyl-1-methyl-1H-pyrazole-4-carboxamide, N-(3′,4′-dichloro-5′-fluorobiphenyl-2-yl)-3-trifluoromethyl-1-methyl-1H-pyrazole-4-carboxamide, N-(3′,5′-difluoro-4′-methylbiphenyl-2-yl)-3-difluoromethyl-1-methyl-1H-pyrazole-4-carboxamide, N-(3′,5′-difluoro-4′-methylbiphenyl-2-yl)-3-trifluoromethyl-1-methyl-1H-pyrazole-4-carboxamide, N-(2-bicyclopropyl-2-ylphenyl)-3-difluoromethyl-1-methyl-1H-pyrazole-4-carboxamide, N-(cis-2-bicyclopropyl-2-ylphenyl)-3-difluoromethyl-1-methyl-1H-pyrazole-4-carboxamide, N-(trans-2-bicyclopropyl-2-ylphenyl)-3-difluoromethyl-1-methyl-1H-pyrazole-4-carboxamide,
carboxylic acid morpholides: dimethomorph, flumorph;
benzamides: flumetover, fluopicolide, fluopyram, zoxamide, N-(3-ethyl-3,5,5-trimethylcyclohexyl)-3-formylamino-2-hydroxybenzamide;
other carboxamides: carpropamid, diclocymet, mandipropamid, oxytetracyclin, silthiofam, N-(6-methoxypyridin-3-yl)cyclopropanecarboxamide;

C) azoles:
triazoles: azaconazole, bitertanol, bromuconazole, cyproconazole, difenoconazole, diniconazole, diniconazole-M, epoxiconazole, fenbuconazole, fluquinconazole, flusilazole, flutriafole, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenole, triticonazole, uniconazole, 1-(4-chlorophenyl)-2-([1,2,4]triazol-1-yl)cycloheptanol;
imidazoles: cyazofamid, imazalil, imazalil sulfate, pefurazoate, prochloraz, triflumizole;
benzimidazoles: benomyl, carbendazim, fuberidazole, thiabendazole;
others: ethaboxam, etridiazole, hymexazole, 1-(4-chlorophenyl)-1-(propyn-2-yloxy)-3-(4-(3,4-dimethoxyphenyl)isoxazol-5-yl)-propan-2-one;

D) nitrogenous heterocyclyl compounds
pyridines: fluazinam, pyrifenox, 3-[5-(4-chlorophenyl)-2,3-dimethylisoxazolidin-3-yl]-pyridine, 3-[5-(4-methylphenyl)-2,3-dimethylisoxazolidin-3-yl]pyridine, 2,3,5,6-tetra-chloro-4-methanesulfonylpyridine, 3,4,5-trichloropyridine-2,6-dicarbonitrile, N-(1-(5-bromo-3-chloropyridin-2-yl)ethyl)-2,4-dichloronicotinamide, N-((5-bromo-3-chloropyridin-2-yl)methyl)-2,4-dichloronicotinamide;
pyrimidines: bupirimate, cyprodinil, diflumetorim, fenarimol, ferimzone, mepanipyrim, nitrapyrin, nuarimol, pyrimethanil;
piperazines: triforine;
pyrroles: fludioxonil, fenpiclonil;
morpholines: aldimorph, dodemorph, dodemorph acetate, fenpropimorph, tridemorph;
piperidines: fenpropidin;
dicarboximides: fluoroimide, iprodione, procymidone, vinclozolin;
nonaromatic 5-membered heterocycles: famoxadone, fenamidone, octhilinone, probenazole, S-allyl 5-amino-2-isopropyl-3-oxo-4-ortho-tolyl-2,3-dihydropyrazole-1-thiocarboxylate;
others: acibenzolar-S-methyl, amisulbrom, anilazine, blasticidin-S, captafol, captan, quinomethionate, dazomet, debacarb, diclomezine, difenzoquat, difenzoquat methylsulfate, fenoxanil, folpet, oxolinic acid, piperalin, proquinazid, pyroquilone, quinoxyfen, triazoxide, tricyclazole, 2-butoxy-6-iodo-3-propylchromen-4-one, 5-chloro-1-(4,6-dimethoxypyrimidin-2-yl)-2-methyl-1H-benzimidazole, N-(4-(3-methoxy-1-(5-methyl-[1,2,3]thiadiazol-4-yl)naphthalen-2-yl)thiazol-2-yl)butyramide, 5-chloro-7-(4-methylpiperidin-1-yl)-6-(2,4,6-trifluorophenyl)-[1,2,4]triazolo[1,5-a]-pyrimidine, 6-(3,4-dichlorophenyl)-5-methyl-[1,2,4]triazolo[1,5-a]pyrimidin-7-ylamine, 6-(4-tert-butylphenyl)-5-methyl-[1,2,4]triazolo[1,5-a]pyrimidin-7-ylamine, 5-methyl-6-(3,5,5-trimethylhexyl)-[1,2,4]triazolo[1,5-a]pyrimidin-7-ylamine, 5-methyl-6-octyl-[1,2,4]triazolo[1,5-a]pyrimidin-7-ylamine, 6-methyl-5-octyl-[1,2,4]triazolo[1,5-a]-pyrimidin-7-ylamine, 6-ethyl-5-octyl-[1,2,4]triazolo[1,5-a]pyrimidin-7-ylamine, 5-ethyl-6-octyl-[1,2,4]triazolo[1,5-a]pyrimidin-7-ylamine, 5-ethyl-6-(3,5,5-trimethylhexyl)-[1,2,4]triazolo[1,5-a]pyrimidin-7-ylamine, 6-octyl-5-propyl-[1,2,4]triazolo[1,5-a]-pyrimidin-7-ylamine, 5-methoxymethyl-6-octyl-[1,2,4]triazolo[1,5-a]pyrimidin-7-ylamine, 6-octyl-5-trifluoromethyl-[1,2,4]triazolo[1,5-a]pyrimidin-7-ylamine and 5-trifluoromethyl-6-(3,5,5-trimethylhexyl)-[1,2,4]triazolo[1,5-a]pyrimidin-7-ylamine;

E) carbamates and dithiocarbamates
thio- and dithiocarbamates: ferbam, mancozeb, maneb, metam, methasulfocarb, metiram, propineb, thiram, zineb, ziram;
carbamates: diethofencarb, benthiavalicarb, iprovalicarb, propamocarb, propamocarb hydrochloride, valiphenal, 4-fluorophenyl N-(1-(1-(4-cyanophenyl)ethanesulfonyl)but-2-yl)carbamate;

F) other fungicides
guanidines: dodine, dodine free base, guazatine, guazatine acetate, iminoctadine, iminoctadine triacetate, iminoctadine tris(albesilate);
nitrophenyl derivatives: binapacryl, dicloran, dinobuton, dinocap, nitrothal-isopropyl, tecnazene;
sulfur-containing heterocyclyl compounds: dithianon, isoprothiolane;
organophosphorus compounds: edifenphos, fosetyl, fosetyl aluminum, iprobenfos, pyrazophos, tolclofos-methyl;
organochlorine compounds: chlorothalonil, dichlofluanid, dichlorophen, flusulfamide, hexachlorobenzene, pencycuron, pentachlorophenol and its salts, phthalide, quintozene, thiophanate methyl, tolylfluanid, N-(4-chloro-2-nitrophenyl)-N-ethyl-4-methylbenzenesulfonamide;
others: biphenyl, bronopol, cyflufenamid, cymoxanil, diphenylamine, metrafenone, mildiomycin, prohexadione-calcium, spiroxamine, tolylfluanid, N-(cyclopropyl-methoxyimino-(6-difluoromethoxy-2,3-difluorophenyl)methyl)-2-phenylacetamide, N′-(4-(4-chloro-3-trifluoromethylphenoxy)-2,5-dimethylphenyl)-N-ethyl-N-methyl-formamidine, N′-(4-(4-fluoro-3-trifluoromethylphenoxy)-2,5-dimethylphenyl)-N-ethyl-N-methylformamidine, N′-(2-methyl-5-trifluoromethyl-4-(3-trimethylsilanylpropoxy)phenyl)-N-ethyl-N-methylformamidine, N′-(5-difluoromethyl-2-methyl-4-(3-trimethylsilanylpropoxy)phenyl)-N-ethyl-N-methylformamidine.

The following list of growth regulators which can be used together with the compounds according to the invention is meant to illustrate possible combinations, but not to limit them:

G) abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfid, indole-3-acetic acid, maleic hydrazide, mefluidide, mepiquat (mepiquat chloride), metconazole, naphthaleneacetic acid, N-6-benzyladenine, paclobutrazole, prohexadione (prohexadione-calcium), prohydrojasmon, thidiazuron, triapenthenol, tributyl phosphorotrithioate, 2,3,5-triiodobenzoic acid, trinexapac-ethyl and uniconazole.

The following list of herbicides which can be used with calcium salts of phosphorous acid is meant to illustrate possible combinations, but not to limit them:

H) Herbicides such as glyphosate, sulfosate, glufosinate, tefluthrin, terbufos, chlorpyrifos, chlorethoxyfos, tebupirimfos, phenoxycarb, diofenolan, pymetrozine, imazethapyr, imazamox, imazapyr, imazapic or dimethenamid-P.

The following list of insecticides which can be used together with calcium salts of phosphorous acid is meant to illustrate possible combinations, but not to limit them:

I) Insecticides such as fipronil, imidacloprid, acetamiprid, nitenpyram, carbofuran, carbosulfan, benfuracarb, dinotefuran, thiacloprid, thiamethoxam, clothianidin, diflubenzuron, flufenoxuron, teflubenzuron and alpha-cypermethrin.

The present invention relates in particular to formulations comprising calcium salts of phosphorous acid and at least one fungicide, for example one or more, for example 1 or 2, active compounds of the groups A) to F) mentioned above. Optionally, they may also comprise further crop protection agents, for example from groups G) to H) mentioned above.

These mixtures are of interest with a view to reducing the application rates, since many of them show, at a reduced total amount of active compounds applied, an improved activity against harmful fungi, in particular for certain indications. By simultaneous joint or separate application of calcium salts of phosphorous acid with at least one active compound of groups A) to F), the fungicidal efficacy is increased in a superadditive manner.

For the purpose of the present application, joint application means that calcium hydrogenphosphite and at least one further active compound are simultaneously present at the site of action (i.e. the plant-damaging fungi to be controlled and their habitat, such as infected plants, plant propagation materials, in particular seed, soils, materials or spaces, and also the plants, plant propagation materials, in particular seed, soils, materials or spaces to be protected against fungal attack) in an amount sufficient for an effective control of fungal growth. This can be achieved by applying the active compound and at least one further active compound together in a joint active compound preparation or simultaneously in at least two separate active compound preparations, or by applying the active compounds successively at the site of action, the interval between the individual active compound applications being chosen such that the active compound applied first is, at the time of application of the further active compound(s), present in a sufficient amount at the site of action. The temporal order in which the active compounds are applied is of minor importance.

In two-component mixtures, i.e. compositions according to the invention which comprise calcium salts of phosphorous acid and a further active compound, for example an active compound from groups A) to I), preferably A) to F), the weight ratio of calcium salt of the phosphorous acid to the further active compound is generally in the range of from 1:50 to 250:1, preferably in the range of from 1:20 to 100:1, in particular in the range of from 1:1 to 20:1.

In three-component mixtures, i.e. compositions according to the invention comprising calcium salts of phosphorous acid and a 1st further active compound and a 2nd further active compound, for example two different active compounds from groups A) to I), preferably A) to F), the weight ratio of calcium salt of the phosphorous acid to the 1st further active compound is preferably in the range of from 1:50 to 250:1, preferably in the range of from 1:20 to 100:1, in particular in the range of from 1:1 to 20:1. The weight ratio of calcium salt of phosphorous acid to the 2nd further active compound is preferably in the range of from 1:50 to 250:1, preferably in the range of from 1:20 to 100:1, in particular in the range of from 1:1 to 20:1. The weight ratio of the 1st further active compound to the 2nd further active compound is preferably in the range of from 1:50 to 50:1, in particular in the range of from 1:10 to 10:1.

The components of the compositions according to the invention may be packaged and used individually or as a readymix or as a kit of parts. In one embodiment of the invention, the kits may comprise one or more, including all, of the components which can be used for preparing an agrochemical composition according to the invention. These kits may comprise, for example, one or more fungicide component(s) and/or an adjuvant component and/or an insecticide component and/or a growth regulator component and/or a herbicide. One or more components may be present combined or preformulated with one another. In the embodiments where more than two components are provided in a kit, the components can be combined with one another and be present packaged in a single container, such as a vessel, bottle, can, bag, sack or canister. In other embodiments, two or more components of a kit may be packaged separately, i.e. not preformulated or mixed. Kits may comprise one or more separate containers, such as vessels, bottles, cans, bags, sacks or canisters, each container comprising a separate component of the agrochemical composition. The components of the composition according to the invention may be packaged and used further individually or as a readymix or as a kit of parts. In both forms, a component may be used separately or together with the other components or as an ingredient of a kit of parts according to the invention for preparing the mixture according to the invention.

The user, for example the farmer, uses the composition according to the invention usually for use in a predosage device, a knapsack sprayer, a spray tank or a spray plane. Here, the agrochemical composition is diluted with water and/or buffer to the desired application concentration, with further auxiliaries being added, if appropriate, thus giving the ready-to-use spray liquor or the inventive agrochemical composition. Usually, from 50 to 500 liters of the ready-to-use spray liquor are applied per hectare of agriculturally utilized area, preferably from 100 to 400 liters.

According to one embodiment, the user may himself mix individual components, such as, for example, parts of a kit or a two- or three-component mixture of the composition according to the invention in a spray tank and, if appropriate, add further auxiliaries (tank mix). In a further embodiment, the user may mix both individual components of the compositions according to the invention and partially pre-mixed components, for example components comprising calcium salts of phosphorous acid and/or active compounds from groups A) to I), in a spray tank, and, if appropriate, add further auxiliaries (tank mix). In a further embodiment, the user may use both individual components of the compositions according to the invention and partially pre-mixed components, for example components comprising calcium salts of phosphorous acid and/or active compounds from groups A) to I), jointly (for example as a tank mix) or in succession.

Preference is given to solid formulations comprising calcium salts of phosphorous acid and at least one active compound from group A) of the strobilurins and in particular selected from the group consisting of azoxystrobin, dimoxystrobin, fluoxastrobin, kresoxim-methyl, orysastrobin, picoxystrobin, pyraclostrobin and trifloxystrobin.

Preference is given to solid formulations comprising calcium salts of phosphorous acid and at least one active compound selected from group B) of the carboxamides and in particular selected from the group consisting of fenhexamid, metalaxyl, mefenoxam, ofurace, dimethomorph, flumorph, fluopicolid (picobenzamid), zoxamide, carpropamid and mandipropamid.

Preference is given to solid formulations comprising calcium salts of phosphorous acid and at least one active compound selected from group C) of the azoles and in particular selected from the group consisting of cyproconazole, difenoconazole, epoxiconazole, fluquinconazole, flusilazole, flutriafole, metconazole, myclobutanil, penconazole, propiconazole, prothioconazole, triadimefon, triadimenol, tebuconazole, tetraconazole, triticonazole, prochloraz, cyazofamid, benomyl, carbendazim and ethaboxam.

Preference is given to solid formulations comprising calcium salts of phosphorous acid and at least one active compound selected from group D) of the nitrogenous heterocyclyl compounds and in particular selected from the group consisting of fluazinam, cyprodinil, fenarimol, mepanipyrim, pyrimethanil, triforine, fludioxonil, fodemorph, fenpropimorph, tridemorph, fenpropidin, iprodione, vinclozolin, famoxadone, fenamidone, probenazole, proquinazid, acibenzolar-S-methyl, captafol, folpet, fenoxanil and quinoxyfen.

Preference is given to solid formulations comprising calcium salts of phosphorous acid and at least one active compound selected from group E) of the carbamates and in particular selected from the group consisting of mancozeb, metiram, propineb, thiram, iprovalicarb, flubenthiavalicarb (also known as benthiavalicarb) and propamocarb. In a further embodiment, preferred active compounds are thio- and dithiocarbamates, such as ferbam, mancozeb, maneb, metam, methasulphocarb, metiram, propineb, thiram, zineb, ziram, in particular dithiocarbamates.

Preference is given to solid formulations comprising calcium salts of phosphorous acid and at least one active compound selected from the fungicides of group F) and in particular selected from the group consisting of dithianon, fosetyl, fosetyl-aluminum, chlorothalonil, dichlofluanid, thiophanate-methyl, cymoxanil, metrafenone, spiroxamine and 5-chloro-7-(4-methylpiperidin-1-yl)-6-(2,4,6-trifluorophenyl)-[1,2,4]-triazolo[1,5-a]pyrimidine.

A preferred embodiment of the invention relates to the compositions A-1 to A-267 listed in table A, in particular in the form of solid formulations, where in each case one row of table A corresponds to an agrochemical composition comprising calcium salts of phosphorous acid (component 1) and the respective further active compound from groups A) to F) stated in the row in question (component 2). A further preferred embodiment also relates to compositions analogous to table A where calcium phosphite CaHPO₃ is used instead of calcium hydrogenphosphite Ca(H₂PO₃)₂. The active compounds in the compositions of table A described are in each case preferably present in a synergistically effective amount.

Particular preference is given to the compositions A-9, A-20, A-186, A-232, A-5, A-66, A-139, A-171, A-196 and A-200, component 1 in each case being Ca(H₂PO₃)₂. Very particular preference is given to the compositions A-9, A-20, A-186 and A-232, component 1 in each case being Ca(H₂PO₃)₂.

TABLE A
Active compound composition comprising calcium salts of phosphorous acid
(component 1) and a further active compound from groups A) to F) (component 2)

| Row | Component 1 | Component 2 |
|---|---|---|
| A-1 | Ca(H₂PO₃)₂ | azoxystrobin |
| A-2 | Ca(H₂PO₃)₂ | dimoxystrobin |
| A-3 | Ca(H₂PO₃)₂ | enestroburin |
| A-4 | Ca(H₂PO₃)₂ | fluoxastrobin |
| A-5 | Ca(H₂PO₃)₂ | kresoxim-methyl |
| A-6 | Ca(H₂PO₃)₂ | metominostrobin |
| A-7 | Ca(H₂PO₃)₂ | orysastrobin |
| A-8 | Ca(H₂PO₃)₂ | picoxystrobin |
| A-9 | Ca(H₂PO₃)₂ | pyraclostrobin |
| A-10 | Ca(H₂PO₃)₂ | pyribencarb |
| A-11 | Ca(H₂PO₃)₂ | trifloxystrobin |
| A-12 | Ca(H₂PO₃)₂ | 2-(2-(6-(3-chloro-2-methylphenoxy)-5-fluoropyrimidin-4- |
| | | yloxy)phenyl)-2-methoxyimino-N-methylacetamide |
| A-13 | Ca(H₂PO₃)₂ | methyl 2-(o-((2,5-dimethylphenyloxymethylene)phenyl)-3- |
| | | methoxyacrylate |
| A-14 | Ca(H₂PO₃)₂ | methyl 3-methoxy-2-(2-(N-(4-methoxyphenyl)- |
| | | cyclopropanecarboximidoylsulfanylmethyl)phenyl)acrylate |
| A-15 | Ca(H₂PO₃)₂ | 2-(2-(3-(2,6-dichlorophenyl)-1-methylallylideneamino- |
| | | oxymethyl)phenyl)-2-methoxyimino-N-methylacetamide |
| A-16 | Ca(H₂PO₃)₂ | benalaxyl |
| A-17 | Ca(H₂PO₃)₂ | benalaxyl-M |
| A-18 | Ca(H₂PO₃)₂ | benodanil |
| A-19 | Ca(H₂PO₃)₂ | bixafen |
| A-20 | Ca(H₂PO₃)₂ | boscalid |
| A-21 | Ca(H₂PO₃)₂ | carboxin |
| A-22 | Ca(H₂PO₃)₂ | fenfuram |
| A-23 | Ca(H₂PO₃)₂ | fenhexamid |
| A-24 | Ca(H₂PO₃)₂ | flutolanil |
| A-25 | Ca(H₂PO₃)₂ | furametpyr |
| A-26 | Ca(H₂PO₃)₂ | isopyrazam |
| A-27 | Ca(H₂PO₃)₂ | isotianil |
| A-28 | Ca(H₂PO₃)₂ | kiralaxyl |
| A-29 | Ca(H₂PO₃)₂ | mepronil |
| A-30 | Ca(H₂PO₃)₂ | metalaxyl |
| A-31 | Ca(H₂PO₃)₂ | metalaxyl-M |
| A-32 | Ca(H₂PO₃)₂ | ofurace |
| A-33 | Ca(H₂PO₃)₂ | oxadixyl |
| A-34 | Ca(H₂PO₃)₂ | oxycarboxin |
| A-35 | Ca(H₂PO₃)₂ | penthiopyrad |
| A-36 | Ca(H₂PO₃)₂ | tecloftalam |
| A-37 | Ca(H₂PO₃)₂ | thifluzamide |
| A-38 | Ca(H₂PO₃)₂ | tiadinil |
| A-39 | Ca(H₂PO₃)₂ | 2-amino-4-methylthiazole-5-carboxanilide |
| A-40 | Ca(H₂PO₃)₂ | 2-chloro-N-(1,1,3-trimethylindan-4-yl)nicotinamide |
| A-41 | Ca(H₂PO₃)₂ | N-(2′,4′-difluorobiphenyl-2-yl)-3-difluoromethyl-1-methyl- |
| | | 1H-pyrazole-4-carboxamide |
| A-42 | Ca(H₂PO₃)₂ | N-(2′,4′-dichlorobiphenyl-2-yl)-3-difluoromethyl-1-methyl- |
| | | 1H-pyrazole-4-carboxamide |
| A-43 | Ca(H₂PO₃)₂ | N-(2′,5′-difluorobiphenyl-2-yl)-3-difluoromethyl-1-methyl- |
| | | 1H-pyrazole-4-carboxamide |
| A-44 | Ca(H₂PO₃)₂ | N-(2′,5-dichlorobiphenyl-2-yl)-3-difluoromethyl-1-methyl- |
| | | 1H-pyrazole-4-carboxamide |
| A-45 | Ca(H₂PO₃)₂ | N-(3′,5′-difluorobiphenyl-2-yl)-3-difluoromethyl-1-methyl- |
| | | 1H-pyrazole-4-carboxamide |
| A-46 | Ca(H₂PO₃)₂ | N-(3′,5′-dichlorobiphenyl-2-yl)-3-difluoromethyl-1-methyl- |
| | | 1H-pyrazole-4-carboxamide |
| A-47 | Ca(H₂PO₃)₂ | N-(3′-fluorobiphenyl-2-yl)-3-difluoromethyl-1-methyl-1H- |
| | | pyrazole-4-carboxamide |
| A-48 | Ca(H₂PO₃)₂ | N-(3′-chlorobiphenyl-2-yl)-3-difluoromethyl-1-methyl-1H- |
| | | pyrazole-4-carboxamide |
| A-49 | Ca(H₂PO₃)₂ | N-(2′-fluorobiphenyl-2-yl)-3-difluoromethyl-1-methyl-1H- |
| | | pyrazole-4-carboxamide |
| A-50 | Ca(H₂PO₃)₂ | N-(2′-chlorobiphenyl-2-yl)-3-difluoromethyl-1-methyl-1H- |
| | | pyrazole-4-carboxamide |
| A-51 | Ca(H₂PO₃)₂ | N-(3′,4′,5′-trifluorobiphenyl-2-yl)-3-difluoromethyl-1-methyl- |
| | | 1H-pyrazole-4-carboxamide |
| A-52 | Ca(H₂PO₃)₂ | N-(2′,4′,5′-trifluorobiphenyl-2-yl)-3-difluoromethyl-1-methyl- |
| | | 1H-pyrazole-4-carboxamide |
| A-53 | Ca(H₂PO₃)₂ | N-[2-(1,1,2,3,3,3-hexafluoropropoxy)phenyl]-3- |
| | | difluoromethyl-1-methyl-1H-pyrazole-4-carboxamide |
| A-54 | Ca(H₂PO₃)₂ | N-[2-(1,1,2,2,-tetrafluoroethoxy)phenyl]-3-difluoromethyl-1- |
| | | methyl-1H-pyrazole-4-carboxamide |
| A-55 | Ca(H₂PO₃)₂ | N-(4′-trifluoromethylthiobiphenyl-2-yl)-3-difluoromethyl-1- |
| | | methyl-1H-pyrazole-4-carboxamide |
| A-56 | Ca(H₂PO₃)₂ | N-(3′,4′-dichloro-5-fluorobiphenyl-2-yl)-3-difluoromethyl-1- |
| | | methyl-1H-pyrazole-4-carboxamide |
| A-57 | Ca(H₂PO₃)₂ | N-(2-(1,3-dimethylbutyl)phenyl)-1,3,3-trimethyl-5-fluoro- |
| | | 1H-pyrazole-4-carboxamide |
| A-58 | Ca(H₂PO₃)₂ | N-(4′-chloro-3′,5′-difluorobiphenyl-2-yl)-3-difluoromethyl-1- |
| | | methyl-1H-pyrazole-4-carboxamide |
| A-59 | Ca(H₂PO₃)₂ | N-(4′-chloro-3′,5′-difluorobiphenyl-2-yl)-3-trifluoromethyl-1- |
| | | methyl-1H-pyrazole-4-carboxamide |
| A-60 | Ca(H₂PO₃)₂ | N-(3′,4′-dichloro-5′-fluorobiphenyl-2-yl)-3-trifluoromethyl-1- |
| | | methyl-1H-pyrazole-4-carboxamide |
| A-61 | Ca(H₂PO₃)₂ | N-(3′,5′-difluoro-4′-methylbiphenyl-2-yl)-3-difluoromethyl-1- |
| | | methyl-1H-pyrazole-4-carboxamide |
| A-62 | Ca(H₂PO₃)₂ | N-(3′,5′-difluoro-4′-methylbiphenyl-2-yl)-3-trifluoromethyl-1- |
| | | methyl-1H-pyrazole-4-carboxamide |
| A-63 | Ca(H₂PO₃)₂ | N-(2-bicyclopropyl-2-ylphenyl)-3-difluoromethyl-1-methyl- |
| | | 1H-pyrazole-4-carboxamide |
| A-64 | Ca(H₂PO₃)₂ | N-(cis-2-bicyclopropyl-2-ylphenyl)-3-difluoromethyl-1- |
| | | methyl-1H-pyrazole-4-carboxamide |
| A-65 | Ca(H₂PO₃)₂ | N-(trans-2-bicyclopropyl-2-ylphenyl)-3-difluoromethyl-1- |
| | | methyl-1H-pyrazole-4-carboxamide |
| A-66 | Ca(H₂PO₃)₂ | dimethomorph |
| A-67 | Ca(H₂PO₃)₂ | flumorph |
| A-68 | Ca(H₂PO₃)₂ | flumetover |
| A-69 | Ca(H₂PO₃)₂ | fluopicolide |
| A-70 | Ca(H₂PO₃)₂ | fluopyram |
| A-71 | Ca(H₂PO₃)₂ | zoxamid |
| A-72 | Ca(H₂PO₃)₂ | N-(3-ethyl-3,5,5-trimethylcyclohexyl)-3-formylamino-2- |
| | | hydroxybenzamide |
| A-73 | Ca(H₂PO₃)₂ | carpropamid |
| A-74 | Ca(H₂PO₃)₂ | diclocymet |
| A-75 | Ca(H₂PO₃)₂ | mandipropamid |
| A-76 | Ca(H₂PO₃)₂ | oxytetracyclin |
| A-77 | Ca(H₂PO₃)₂ | silthiofam |
| A-78 | Ca(H₂PO₃)₂ | N-(6-methoxypyridin-3-yl)cyclopropanecarboxamide |
| A-79 | Ca(H₂PO₃)₂ | azaconazole |
| A-80 | Ca(H₂PO₃)₂ | bitertanol |
| A-81 | Ca(H₂PO₃)₂ | bromuconazole |
| A-82 | Ca(H₂PO₃)₂ | cyproconazole |
| A-83 | Ca(H₂PO₃)₂ | difenoconazole |
| A-84 | Ca(H₂PO₃)₂ | diniconazole |
| A-85 | Ca(H₂PO₃)₂ | diniconazole-M |
| A-86 | Ca(H₂PO₃)₂ | epoxiconazole |
| A-87 | Ca(H₂PO₃)₂ | fenbuconazole |
| A-88 | Ca(H₂PO₃)₂ | fluquinconazole |
| A-89 | Ca(H₂PO₃)₂ | flusilazole |
| A-90 | Ca(H₂PO₃)₂ | flutriafol |
| A-91 | Ca(H₂PO₃)₂ | hexaconazole |
| A-92 | Ca(H₂PO₃)₂ | imibenconazole |
| A-93 | Ca(H₂PO₃)₂ | ipconazole |
| A-94 | Ca(H₂PO₃)₂ | metconazole |
| A-95 | Ca(H₂PO₃)₂ | myclobutanil |
| A-96 | Ca(H₂PO₃)₂ | oxpoconazole |
| A-97 | Ca(H₂PO₃)₂ | paclobutrazole |
| A-98 | Ca(H₂PO₃)₂ | penconazole |
| A-99 | Ca(H₂PO₃)₂ | propiconazole |
| A-100 | Ca(H₂PO₃)₂ | prothioconazole |
| A-101 | Ca(H₂PO₃)₂ | simeconazole |
| A-102 | Ca(H₂PO₃)₂ | tebuconazole |
| A-103 | Ca(H₂PO₃)₂ | tetraconazole |
| A-104 | Ca(H₂PO₃)₂ | triadimefon |
| A-105 | Ca(H₂PO₃)₂ | triadimenol |
| A-106 | Ca(H₂PO₃)₂ | triticonazole |
| A-107 | Ca(H₂PO₃)₂ | uniconazole |
| A-108 | Ca(H₂PO₃)₂ | 1-(4-chlorophenyl)-2-([1,2,4]triazol-1-yl)cycloheptanol |
| A-109 | Ca(H₂PO₃)₂ | cyazofamid |
| A-110 | Ca(H₂PO₃)₂ | imazalil |
| A-111 | Ca(H₂PO₃)₂ | imazalil-sulfate |
| A-112 | Ca(H₂PO₃)₂ | pefurazoate |
| A-113 | Ca(H₂PO₃)₂ | prochloraz |
| A-114 | Ca(H₂PO₃)₂ | triflumizole |
| A-115 | Ca(H₂PO₃)₂ | benomyl |
| A-116 | Ca(H₂PO₃)₂ | carbendazim |
| A-117 | Ca(H₂PO₃)₂ | fuberidazole |
| A-118 | Ca(H₂PO₃)₂ | thiabendazole |
| A-119 | Ca(H₂PO₃)₂ | ethaboxam |
| A-120 | Ca(H₂PO₃)₂ | etridiazole |
| A-121 | Ca(H₂PO₃)₂ | hymexazole |
| A-122 | Ca(H₂PO₃)₂ | 1-(4-chlorophenyl)-1-(propyn-2-yloxy)-3-(4-(3,4-dimethoxy- |
| | | phenyl)isoxazol-5-yl)propan-2-one |
| A-123 | Ca(H₂PO₃)₂ | fluazinam |
| A-124 | Ca(H₂PO₃)₂ | pyrifenox |
| A-125 | Ca(H₂PO₃)₂ | 3-[5-(4-chlorophenyl)-2,3-dimethylisoxazolidin-3-yl]pyridine |
| A-126 | Ca(H₂PO₃)₂ | 3-[5-(4-methylphenyl)-2,3-dimethylisoxazolidin-3- |
| | | yl]pyridine |
| A-127 | Ca(H₂PO₃)₂ | 2,3,5,6-tetrachloro-4-methanesulfonylpyridine |
| A-128 | Ca(H₂PO₃)₂ | 3,4,5-trichloropyridine-2,6-dicarbonitrile |
| A-129 | Ca(H₂PO₃)₂ | N-(1-(5-bromo-3-chloropyridin-2-yl)ethyl)-2,4-di- |
| | | chloronicotinamide |
| A-130 | Ca(H₂PO₃)₂ | N-((5-bromo-3-chloropyridin-2-yl)methyl)-2,4-dichloro- |
| | | nicotinamide |
| A-131 | Ca(H₂PO₃)₂ | bupirimate |
| A-132 | Ca(H₂PO₃)₂ | cyprodinil |
| A-133 | Ca(H₂PO₃)₂ | diflumetorim |
| A-134 | Ca(H₂PO₃)₂ | fenarimol |
| A-135 | Ca(H₂PO₃)₂ | ferimzone |
| A-136 | Ca(H₂PO₃)₂ | mepanipyrim |
| A-137 | Ca(H₂PO₃)₂ | nitrapyrin |
| A-138 | Ca(H₂PO₃)₂ | nuarimol |
| A-139 | Ca(H₂PO₃)₂ | pyrimethanil |
| A-140 | Ca(H₂PO₃)₂ | triforine |
| A-141 | Ca(H₂PO₃)₂ | fenpiclonil |
| A-142 | Ca(H₂PO₃)₂ | fludioxonil |
| A-143 | Ca(H₂PO₃)₂ | aldimorph |
| A-144 | Ca(H₂PO₃)₂ | dodemorph |
| A-145 | Ca(H₂PO₃)₂ | dodemorph-acetate |
| A-146 | Ca(H₂PO₃)₂ | fenpropimorph |
| A-147 | Ca(H₂PO₃)₂ | tridemorph |
| A-148 | Ca(H₂PO₃)₂ | fenpropidin |
| A-149 | Ca(H₂PO₃)₂ | fluoroimide |
| A-150 | Ca(H₂PO₃)₂ | iprodione |
| A-151 | Ca(H₂PO₃)₂ | procymidone |
| A-152 | Ca(H₂PO₃)₂ | vinclozolin |
| A-153 | Ca(H₂PO₃)₂ | famoxadone |
| A-154 | Ca(H₂PO₃)₂ | fenamidon |
| A-155 | Ca(H₂PO₃)₂ | octhilinone |
| A-156 | Ca(H₂PO₃)₂ | probenazole |
| A-157 | Ca(H₂PO₃)₂ | S-allyl 5-amino-2-isopropyl-4-orthotolylpyrazol-3-one-1- |
| | | thiocarboxylate |
| A-158 | Ca(H₂PO₃)₂ | acibenzolar-S-methyl |
| A-159 | Ca(H₂PO₃)₂ | amisulbrom |
| A-160 | Ca(H₂PO₃)₂ | anilazine |
| A-161 | Ca(H₂PO₃)₂ | blasticidin-S |
| A-162 | Ca(H₂PO₃)₂ | captafol |
| A-163 | Ca(H₂PO₃)₂ | captan |
| A-164 | Ca(H₂PO₃)₂ | chinomethionate |
| A-165 | Ca(H₂PO₃)₂ | dazomet |
| A-166 | Ca(H₂PO₃)₂ | debacarb |
| A-167 | Ca(H₂PO₃)₂ | diclomezine |
| A-168 | Ca(H₂PO₃)₂ | difenzoquat |
| A-169 | Ca(H₂PO₃)₂ | difenzoquat-methylsulfate |
| A-170 | Ca(H₂PO₃)₂ | fenoxanil |
| A-171 | Ca(H₂PO₃)₂ | folpet |
| A-172 | Ca(H₂PO₃)₂ | oxolinic acid |
| A-173 | Ca(H₂PO₃)₂ | piperalin |
| A-174 | Ca(H₂PO₃)₂ | proquinazid |
| A-175 | Ca(H₂PO₃)₂ | pyroquilon |
| A-176 | Ca(H₂PO₃)₂ | quinoxyfen |
| A-177 | Ca(H₂PO₃)₂ | triazoxid |
| A-178 | Ca(H₂PO₃)₂ | tricyclazole |
| A-179 | Ca(H₂PO₃)₂ | 2-butoxy-6-iodo-3-propylchromen-4-one |
| A-180 | Ca(H₂PO₃)₂ | 5-chloro-1-(4,6-dimethoxypyrimidin-2-yl)-2-methyl-1H- |
| | | benzimidazole |
| A-181 | Ca(H₂PO₃)₂ | N-(4-(3-methoxy-1-(5-methyl-[1,2,3]thiadiazol-4-yl)- |
| | | naphthalen-2-yl)thiazol-2-yl)butyramide |
| A-182 | Ca(H₂PO₃)₂ | 5-chloro-7-(4-methylpiperidin-1-yl)-6-(2,4,6-trifluoro- |
| | | phenyl)[1,2,4]triazolo[1,5-a]pyrimidine |
| A-183 | Ca(H₂PO₃)₂ | 6-(3,4-dichlorophenyl)-5-methyl-[1,2,4]triazolo-[1,5- |
| | | a]pyrimidin-7-ylamine |
| A-184 | Ca(H₂PO₃)₂ | 6-(4-tert-butylphenyl)-5-methyl-[1,2,4]triazolo[1,5- |
| | | a]pyrimidin-7-ylamine |
| A-185 | Ca(H₂PO₃)₂ | 5-methyl-6-(3,5,5-trimethylhexyl)[1,2,4]triazolo[1,5- |
| | | a]pyrimidin-7-ylamine |
| A-186 | Ca(H₂PO₃)₂ | 5-methyl-6-octyl-[1,2,4]triazolo[1,5-a]pyrimidin-7-ylamine |
| A-187 | Ca(H₂PO₃)₂ | 6-methyl-5-octyl-[1,2,4]triazolo[1,5-a]pyrimidin-7-ylamine |
| A-188 | Ca(H₂PO₃)₂ | 6-ethyl-5-octyl-[1,2,4]triazolo[1,5-a]pyrimidin-7-ylamine |
| A-189 | Ca(H₂PO₃)₂ | 5-ethyl-6-octyl-[1,2,4]triazolo[1,5-a]pyrimidin-7-ylamine |
| A-190 | Ca(H₂PO₃)₂ | 5-ethyl-6-(3,5,5-trimethylhexyl)-[1,2,4]triazolo[1,5- |
| | | a]pyrimidin-7-ylamine |
| A-191 | Ca(H₂PO₃)₂ | 6-octyl-5-propyl-[1,2,4]triazolo[1,5-a]pyrimidin-7-ylamine |
| A-192 | Ca(H₂PO₃)₂ | 5-methoxymethyl-6-octyl-[1,2,4]triazolo[1,5-a]pyrimidin-7- |
| | | ylamine |
| A-193 | Ca(H₂PO₃)₂ | 6-octyl-5-trifluoromethyl-[1,2,4]triazolo[1,5-a]pyrimidin-7-yl- |
| | | amine |
| A-194 | Ca(H₂PO₃)₂ | 5-trifluoromethyl-6-(3,5,5-trimethylhexyl)-[1,2,4]tri- |
| | | azolo[1,5-a]pyrimidin-7-ylamine |
| A-195 | Ca(H₂PO₃)₂ | ferbam |
| A-196 | Ca(H₂PO₃)₂ | mancozeb |
| A-197 | Ca(H₂PO₃)₂ | maneb |
| A-198 | Ca(H₂PO₃)₂ | metam |
| A-199 | Ca(H₂PO₃)₂ | methasulfocarb |
| A-200 | Ca(H₂PO₃)₂ | metiram |
| A-201 | Ca(H₂PO₃)₂ | propineb |
| A-202 | Ca(H₂PO₃)₂ | thiram |
| A-203 | Ca(H₂PO₃)₂ | zineb |
| A-204 | Ca(H₂PO₃)₂ | ziram |
| A-205 | Ca(H₂PO₃)₂ | diethofencarb |
| A-206 | Ca(H₂PO₃)₂ | benthiavalicarb |
| A-207 | Ca(H₂PO₃)₂ | flubenthiavalicarb |
| A-208 | Ca(H₂PO₃)₂ | iprovalicarb |
| A-209 | Ca(H₂PO₃)₂ | propamocarb |
| A-210 | Ca(H₂PO₃)₂ | propamocarb hydrochloride |
| A-211 | Ca(H₂PO₃)₂ | valiphenal |
| A-212 | Ca(H₂PO₃)₂ | 4-fluorophenyl N-(1-(1-(4-cyanophenyl)ethanesulfonyl)but- |
| | | 2-yl)carbamate |
| A-213 | Ca(H₂PO₃)₂ | dodine |
| A-214 | Ca(H₂PO₃)₂ | dodine free base |
| A-215 | Ca(H₂PO₃)₂ | guazatine |
| A-216 | Ca(H₂PO₃)₂ | guazatine acetate |
| A-217 | Ca(H₂PO₃)₂ | iminoctadine |
| A-218 | Ca(H₂PO₃)₂ | iminoctadine triacetate |
| A-219 | Ca(H₂PO₃)₂ | iminoctadine tris(albesilate) |
| A-220 | Ca(H₂PO₃)₂ | kasugamycin |
| A-221 | Ca(H₂PO₃)₂ | kasugamycin hydrochloride hydrate |
| A-222 | Ca(H₂PO₃)₂ | polyoxin |
| A-223 | Ca(H₂PO₃)₂ | streptomycin |
| A-224 | Ca(H₂PO₃)₂ | validamycin A |
| A-225 | Ca(H₂PO₃)₂ | binapacryl |
| A-226 | Ca(H₂PO₃)₂ | dicloran |
| A-227 | Ca(H₂PO₃)₂ | dinobuton |
| A-228 | Ca(H₂PO₃)₂ | dinocap |
| A-229 | Ca(H₂PO₃)₂ | nitrothal-isopropyl |
| A-230 | Ca(H₂PO₃)₂ | tecnazen |
| A-231 | Ca(H₂PO₃)₂ | fentin salts |
| A-232 | Ca(H₂PO₃)₂ | dithianon |
| A-233 | Ca(H₂PO₃)₂ | isoprothiolan |
| A-234 | Ca(H₂PO₃)₂ | edifenphos |
| A-235 | Ca(H₂PO₃)₂ | fosetyl, fosetyl-aluminum |
| A-236 | Ca(H₂PO₃)₂ | iprobenfos |
| A-237 | Ca(H₂PO₃)₂ | phosphorous acid and derivatives |
| A-238 | Ca(H₂PO₃)₂ | pyrazophos |
| A-239 | Ca(H₂PO₃)₂ | tolclofos-methyl |
| A-240 | Ca(H₂PO₃)₂ | chlorthalonil |
| A-241 | Ca(H₂PO₃)₂ | dichlofluanid |
| A-242 | Ca(H₂PO₃)₂ | dichlorphen |
| A-243 | Ca(H₂PO₃)₂ | flusulfamid |
| A-244 | Ca(H₂PO₃)₂ | hexachlorobenzene |
| A-245 | Ca(H₂PO₃)₂ | pencycuron |
| A-246 | Ca(H₂PO₃)₂ | pentachlorophenol and salts |
| A-247 | Ca(H₂PO₃)₂ | phthalide |
| A-248 | Ca(H₂PO₃)₂ | quintozene |
| A-249 | Ca(H₂PO₃)₂ | thiophanate-methyl |
| A-250 | Ca(H₂PO₃)₂ | tolylfluanide |
| A-251 | Ca(H₂PO₃)₂ | N-(4-chloro-2-nitrophenyl)-N-ethyl- |
| | | 4-methylbenzenesulfonamide |
| A-252 | Ca(H₂PO₃)₂ | Bordeaux mixture |
| A-253 | Ca(H₂PO₃)₂ | biphenyl |
| A-254 | Ca(H₂PO₃)₂ | bronopol |
| A-255 | Ca(H₂PO₃)₂ | cyflufenamid |
| A-256 | Ca(H₂PO₃)₂ | cymoxanil |
| A-257 | Ca(H₂PO₃)₂ | diphenylamine |
| A-258 | Ca(H₂PO₃)₂ | metrafenone |
| A-259 | Ca(H₂PO₃)₂ | mildiomycin |
| A-260 | Ca(H₂PO₃)₂ | prohexadione-calcium |
| A-261 | Ca(H₂PO₃)₂ | spiroxamine |
| A-262 | Ca(H₂PO₃)₂ | tolylfluanid |
| A-263 | Ca(H₂PO₃)₂ | N-(cyclopropylmethoxyimino-(6-difluoromethoxy-2,3- |
| | | difluorophenyl)methyl)-2-phenylacetamide |
| A-264 | Ca(H₂PO₃)₂ | N′-(4-(4-chloro-3-trifluoromethylphenoxy)-2,5-dimethyl- |
| | | phenyl)-N-ethyl-N-methylformamidine |
| A-265 | Ca(H₂PO₃)₂ | N′-(4-(4-fluoro-3-trifluoromethylphenoxy)-2,5-dimethyl- |
| | | phenyl)-N-ethyl-N-methylformamidine |
| A-266 | Ca(H₂PO₃)₂ | N′-(2-methyl-5-trifluoromethyl-4-(3-trimethylsilanyl- |
| | | propoxy)phenyl)-N-ethyl-N-methylformamidine |
| A-267 | Ca(H₂PO₃)₂ | N′-(5-difluoromethyl-2-methyl-4-(3-trimethylsilanyl- |
| | | propoxy)phenyl)-N-ethyl-N-methylformamidine |

The active compounds mentioned above as component 2, their preparation and their action against harmful fungi are known (cf.: http://www.alanwood.net/pesticides/); they are commercially available. The compounds named according to IUPAC, their preparation and their fungicidal action are likewise known (cf. EP-A 226 917; EP-A 1 028 125; EP-A 1 035 122; EP-A 1 201 648; WO 98/46608; WO 99/24413; WO 03/14103; WO 03/053145; WO 03/066609; WO 04/049804).

In a preferred embodiment, the calcium salt of phosphorous acid is a calcium hydrogenphosphite and the fungicide comprises at least one fungicide selected from the group consisting of dithianon, pyraclostrobin, boscalid, 5-ethyl-6-octyl-[1,2,4]triazolo[1,5-a]pyrimidin-7-ylamine, dimethomorph, metiram, mancozeb, folpet and kresoxim-methyl. Preferably, the fungicide is at least one fungicide selected from the group consisting of dithianon, pyraclostrobin, boscalid and 5-ethyl-6-octyl-[1,2,4]triazolo[1,5-a]pyrimidin-7-ylamine.

In a particularly preferred embodiment, the calcium salt of phosphorous acid is a calcium hydrogenphosphite and the fungicide is a sulfur-containing heterocyclyl compound, preferably dithianon. The weight ratio of calcium hydrogenphosphite to the fungicide is in most cases from 50/1 to 1/20, preferably from 10/1 to 1/5, in particular from 7/1 to 1/1.

In a further particularly preferred embodiment, the calcium salt of phosphorous acid is a calcium hydrogenphosphite and the fungicide is a strobilurin, preferably pyraclostrobin. The weight ratio of calcium hydrogenphosphite to the fungicide is in most cases from 3/1 to 1/500, preferably from 1/10 to 1/200, in particular from 1/80 to 1/120.

In a further particularly preferred embodiment, the calcium salt of phosphorous acid is a calcium hydrogenphosphite and the fungicide is a carboxanilide, preferably boscalid. The weight ratio of calcium hydrogenphosphite to the fungicide is in most cases from 3/1 to 1/300, preferably from 1/5 to 1/100, in particular from 1/35 to 1/65.

In a further particularly preferred embodiment, the calcium salt of phosphorous acid is a calcium hydrogenphosphite and the fungicide is a fungicidal [1,2,4]triazolo[1,5-a]pyrimidine, preferably 5-ethyl-6-octyl-[1,2,4]triazolo[1,5-a]pyrimidin-7-ylamine. The weight ratio of calcium hydrogenphosphite to the fungicide is in most cases from 5/1 to 1/200, preferably from 1/1 to 1/50, and particularly from 1/5 to 1/25.

In a further particularly preferred embodiment, the calcium salt of phosphorous acid is a calcium hydrogenphosphite and the fungicide is dithianon, and a second fungicide selected from the group consisting of dithianon, pyraclostrobin, boscalid, 5-ethyl-6-octyl-[1,2,4]triazolo[1,5-a]pyrimidin-7-ylamine, dimethomorph, metiram, mancozeb, folpet and kresoxim-methyl. The weight ratio of calcium hydrogenphosphite to the second fungicide is in most cases from 50/1 to 1/20, preferably from 15/1 to 1/5, in particular from 10/1 to 1/1.

The total amount of pesticides is from 1 to 40% by weight, preferably from 3 to 30% by weight, based on the solid formulation.

The total amount of active compound is the sum of pesticides and calcium salts of phosphorous acid in the solid formulation. The total amount of active compounds is at least 40% by weight, preferably at least 50% by weight and in particular at least 60% by weight, based on the solid formulation.

The invention furthermore provides a solid formulation for crop protection, the formulation comprising a calcium salt of phosphorous acid and a fungicide. Examples of types of solid formulations are wettable powders or dusts (WP, SP, SS, WS, DP, DS) or granules (SG, WG, GR, GG, MG) which may be either soluble in water (soluble) or dispersible in water (wettable). The solid formulation according to the invention is preferably in the form of granules, especially water-soluble granules or water-dispersible granules. The mean particle size of the granules is generally from 0.05 to 5 mm, preferably from 0.1 to 1 mm.

The calcium salt of phosphorous acid in the solid formulation may comprise calcium hydrogenphosphate and/or calcium phosphite. Preferably, the calcium salt of phosphorous acid in the solid formulation comprises calcium hydrogenphosphite.

The solid formulation according to the invention may furthermore also comprise auxiliaries customary for formulating crop protection agents, the choice of the auxiliaries depending on the specific use form and/or the active compound. Examples of auxiliaries customary for formulating crop protection agents are solvents, solid carriers, surfactants (such as solubilizers, protective colloids, wetting agents and tackifiers), lumping agents, organic and inorganic thickeners, bactericides, antifreeze agents, antifoams, colorants and adhesives (for example for

Examples of solvents are water, organic solvents, such as mineral oil fractions of medium to high boiling point, such as kerosene and diesel oil, furthermore coal tar oils, and also oils of vegetable or animal origin, aliphatic, cyclic and aromatic hydrocarbons, for example paraffins, tetrahydronaphthalene, alkylated naphthalenes, and derivatives thereof, alkylated benzenes and derivatives thereof, alcohols, such as methanol, ethanol, propanol, butanol and cyclohexanol, glycols, ketones, such as cyclohexanone, gamma-butyrolactone, dimethyl fatty acid amides, fatty acids and fatty esters and strongly polar solvents, for example amines, such as N-methylpyrrolidone. In principle, it is also possible to use solvent mixtures, and also mixtures of the solvents mentioned above and water. Preferably, they comprise water as solvent. The solid formulation according to the invention is usually essentially free of organic solvents. Preferably, the solid formulation comprises at most 20% by weight, preferably at most 10% by weight, particularly preferably at most 5% by weight, in particular at most 2% by weight and especially at most 0.5% by weight of organic solvent. Preferably, the solid formulation comprises at most 10% by weight, preferably at most 5% by weight, particularly preferably at most 2% by weight, in particular at most 1% by weight and especially at most 0.3% by weight of water, the water bound as water of crystallization in the calcium salt of phosphorous acid not being taken into account.

The following solid carriers may be mentioned by way of example: a) inorganic compounds: mineral earths, such as silica gels, silicates, talc, kaolin, attaclay, limestone, lime, chalk, loess, clay, dolomite, diatomaceous earth, calcium sulfate and magnesium sulfate, magnesium oxide, attapulgite, montmorillonite, mica, vermiculite, synthetic silicic acids, amorphous silicic acids and synthetic calcium silicates or mixtures thereof; b) organic compounds: ground plastics, fertilizers, such as ammonium sulfate, ammonium phosphate, ammonium nitrate, thiourea and urea, products of vegetable origin, such as cereal meals, tree bark meal, wood meal and nutshell meal, cellulose powders. A preferred solid carrier is silicic acid. The solid carriers can also be used as lumping agents, such as silicic acids. Accordingly, for the purpose of the present invention, lumping agents are solid carriers.

The solid formulation according to the invention preferably comprises at most 25% by weight, particularly preferably at most 20% by weight, in particular at most 10% by weight and especially at most 5% by weight of solid carriers. The low content of such solid carriers permits a higher content of active compounds and other auxiliaries.

Suitable surfactants (adjuvants, wetting agents, tackifiers, dispersants or emulsifiers) are:

alkali metal, alkaline earth metal and ammonium salts of aromatic sulfonic acids, for example of lignosulfonic acid (Borresperse® types, Borregaard, Norway),

phenolsulfonic acid, naphthalenesulfonic acid (Morwet® types, Akzo Nobel, USA) and dibutylnaphthalenesulfonic acid (Nekal® types, BASF, Germany), and also salts of fatty acids, alkyl- and alkylarylsulfonates, alkyl, lauryl ether and fatty alcohol sulfates, and also salts of sulfated hexa-, hepta- and octadecanols

and also of fatty alcohol glycol ethers, condensates of sulfonated naphthalene and its derivatives with formaldehyde, condensates of naphthalene or of the

naphthalenesulfonic acids with phenol and formaldehyde, polyoxyethylene octylphenol ether, ethoxylated isooctylphenol, octylphenol or nonylphenol, alkylphenyl polyglycol ether, tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors, and also proteins, denatured proteins,

polysaccharides (for example methylcellulose), hydrophobically modified starches, polyvinyl alcohol (Mowiol® types, Clariant, Switzerland), polycarboxylates (Sokalan® types, BASF, Germany), polyalkoxylates, polyvinylamine (Lupamin® types, BASF, Germany), polyethyleneimine (Lupasol® types, BASF, Germany), polyvinylpyrrolidone and copolymers thereof. Suitable are furthermore, for example, phosphoric esters of fatty alcohol alkoxylates (Lutensit® A-EP, BASF, Germany) and alkylpolyglucosides.

Preferably, the solid formulation according to the invention comprises at least one aromatic sulfonic acid and/or a salt thereof. In one embodiment, the formulation may also comprise more than one, for example two or three. Suitable aromatic sulfonic acids and/or salts thereof are, for example, lignosulfonic acid (Borresperse® types, Borregaard, Norway), phenolsulfonic acid, naphthalenesulfonic acid (Morwet® types, Akzo Nobel, USA) and dibutylnaphthalenesulfonic acid (Nekal® types, BASF, Germany), alkylarylsulfonates, condensates of sulfonated naphthalene and its derivatives with formaldehyde (Tamol® types, BASF, Germany), condensates of naphthalenesulfonic acids with phenol and formaldehyde. Suitable salts are, for example, alkali metal, alkaline earth metal or ammonium salts. The content of aromatic sulfonic acids and/or salts thereof is usually from 1 to 40% by weight, preferably from 5 to 30% by weight, particularly preferably from 10 to 25% by weight, based on the total weight of the solid formulation.

Preferably, the solid formulation comprises at least two different aromatic sulfonic acids and/or salts thereof. The weight ratio of two of the aromatic sulfonic acids and/or salts thereof is usually in the range of from 10:1 to 1:1, preferably in the range of from 5:1 to 1:1, in particular in the range of from 2:1 to 1:1. Particularly preferably, the solid formulation comprises a lignosulfonic acid or a salt thereof and also a condensate of naphthalenesulfonic acids with formaldehyde and/or phenol or a salt thereof. It comprises in particular sodium lignosulfonate and naphthalenesulfonic acid/formaldehyde condensate sodium salt. The total amount of the at least two different aromatic sulfonic acids and/or their salts is usually from 10 to 45% by weight, preferably from 15 to 40% by weight, particularly preferably from 20 to 35% by weight, based on the total weight of the solid formulation.

Particularly preferably, the solid formulation comprises at least two different aromatic sulfonic acids and/or salts thereof, and also at least one further surfactant. The further surfactant is preferably a phosphoric ester of a fatty alcohol alkoxylate, alkylnaphthalene sulfonate, alkylglucoside, lauryl sulfate or an alkali metal, alkaline earth metal or ammonium salt thereof. The content of the further surfactants is usually from 0.1 to 10% by weight, preferably from 0.5 to 5% by weight, particularly preferably from 1 to 3% by weight, based on the total weight of the solid formulation.

The proportion of surfactants is generally in the range from 0.5 to 60% by weight, preferably from 10 to 50% by weight, particularly preferably from 20 to 40% by weight, based on the total weight of the solid formulation.

Furthermore, the following may be used as further auxiliaries in amounts customary per se:

Water-soluble salts, for example water-soluble ammonium salts, such as ammonium sulfate, ammonium bisulfate, ammonium chloride, ammonium acetate, ammonium formate, ammonium oxalate, ammonium carbonate, ammonium bicarbonate, ammonium thiosulfate, ammonium hydrogen diphosphate, ammonium dihydrogen monophosphate, ammonium sodium hydrogen phosphate, ammonium thiocyanate, ammonium sulfamate or ammonium carbamate; or water-soluble sulfates, such as sodium sulfate, potassium sulfate, ammonium sulfate; or other water-soluble salts, such as sodium chloride, potassium chloride, sodium acetate. Preference is given to water-soluble ammonium salts or sulfates, in particular ammonium sulfate;

Binders, such as polyvinylpyrrolidone, polyvinyl alcohol, partially hydrolyzed polyvinyl acetate, carboxymethylcellulose, starch, vinylpyrrolidone/vinyl acetate copolymers and polyvinyl acetate or mixtures thereof;

Complex formers, such as salts of ethylenediaminetetraacetic acid (EDTA), salts of trinitrilotriacetic acid or salts of polyphosphoric acids or mixtures thereof;

Thickeners, such as polysaccharides and also organic and inorganic sheet minerals, such as xanthan gum (Kelzan®, CP Kelco, USA), Rhodopol® 23 (Rhodia, France) or Veegum® (R.T. Vanderbilt, USA) or Attaclay® (Engelhard Corp., NJ, USA). The solid formulation according to the invention is usually essentially free of thickeners.

Bactericides, such as those based on diclorophen and benzyl alcohol hemiformal (Proxel® from ICI or Acticide® RS from Thor Chemie and Kathon® MK from Rohm & Haas), and also isothiazolinone derivatives, such as alkylisothiazolinones and benzisothiazolinones (Acticide® MBS from Thor Chemie). The solid formulation according to the invention is usually essentially free of bactericides.

Antifreeze agents, such as ethylene glycol, propylene glycol, urea and glycerol. The solid formulation according to the invention is usually essentially free of antifreeze agents.

Antifoams, such as silicone emulsions (such as, for example, Silikon® SRE, Wacker, Germany or Rhodorsil®, Rhodia, France), long-chain alcohols, fatty acids, salts of fatty acids, organofluorine compounds and mixtures thereof;

Colorants (both sparingly water-soluble pigments and water-soluble dyes), such as the dyes and pigments known under the names Rhodamin B, C. I. Pigment Red 112 and C. I. Solvent Red 1, Pigment blue 15:4, Pigment blue 15:3, Pigment blue 15:2, Pigment blue 15:1, Pigment blue 80, Pigment yellow 1, Pigment yellow 13, Pigment red 48:2, Pigment red 48:1, Pigment red 57:1, Pigment red 53:1, Pigment orange 43, Pigment orange 34, Pigment orange 5, Pigment green 36, Pigment green 7, Pigment white 6, Pigment brown 25, Basic violet 10, Basic violet 49, Acid red 51, Acid red 52, Acid red 14, Acid blue 9, Acid yellow 23, Basic red 10, Basic red 108. The solid formulation according to the invention is usually essentially free of colorants.

The solid formulation according to the invention can be prepared by known processes:

a) water-dispersible granules and water-soluble granules (WG, SG)

50 parts by weight of the calcium salt of phosphorous acid are ground finely with addition of 50 parts by weight of dispersants and wetters and made into water-dispersible or water-soluble granules by means of technical appliances (for example extrusion, spray tower, fluidized bed). Dilution with water gives a stable dispersion or solution of the active compound. The formulation has an active compound content of 50% by weight.

b) Water-dispersible powders and water-soluble powders (WP, SP, SS, WS)

75 parts by weight of the calcium salt of phosphorous acid are ground in a rotor-stator mill with addition of 25 parts by weight of dispersants, wetters and silica gel. Dilution with water gives a stable dispersion or solution of the active compound. The active compound content of the formulation is 75% by weight.

c) Dusts (DP, DS)

5 parts by weight of the calcium salt of phosphorous acid are ground finely and mixed intimately with 95 parts by weight of finely divided kaolin. This gives a dustable product with an active compound content of 5% by weight.

d) Granules (GR, FG, GG, MG)

0.5 part by weight of the calcium salt of phosphorous acid is ground finely and associated with 99.5 parts by weight of carriers. Current methods are extrusion, spray-drying or the fluidized bed. This gives granules with an active compound content of 0.5% by weight to be applied undiluted.

Advantageously, the process according to the invention for preparing a solid formulation comprising a calcium salt of phosphorous acid used is a process where an aqueous composition comprising calcium salts of phosphorous acid is dried. Usually, initially an aqueous composition comprising calcium salts of phosphorous acid, fungicide and optionally formulation auxiliaries is initially provided. The aqueous composition is preferably a suspension or a slurry. Particularly preferably, the aqueous composition comprises from 20 to 80% by weight, preferably from 30 to 70% by weight and particularly preferably from 40 to 60% by weight of water, in each case based on the total amount of the aqueous composition. The aqueous composition can be ground, for example in a bead mill.

The aqueous composition can be dried by spray drying or other granulation processes. Preference is given to granulation processes such as extruder granulation, fluidized-bed granulation, mixer granulation and disk granulation. Suitable temperature ranges are product temperatures of from 20 to 200° C., preferably from 40 to 100° C. The fluidized-bed granulation (FBG) is particularly suitable. Depending on the desired composition of the formulation, an aqueous solution, emulsion or suspension comprising all ingredients of the recipe is sprayed and agglomerized in an FBG apparatus. Drying gives a water content of the solid formulation of at most 10% by weight, preferably at most 5% by weight, particularly preferably at most 2% by weight, in particular at most 1% by weight and especially at most 0.3% by weight of water, water bound as water of crystallization in the calcium salt of phosphorous acid not being taken into account.

However, optionally it is also possible to initially charge, in the apparatus, active compound salts and/or inorganic ammonium salts, which are sprayed with a solution or emulsion/suspension of the remaining ingredients of the recipe and agglomerized as a result. It is furthermore possible to apply aqueous solutions, emulsions or suspensions comprising certain ingredients of the recipe in succession to active compound granules, an active compound salt and/or an inorganic ammonium salt, and thus to obtain various coating layers.

In general, the granules are dried sufficiently during fluidized-bed granulation. However, it may be advantageous to have the granulation followed by a separate drying step in the same or in a separate dryer. Subsequently to granulation/drying, the product is cooled and sieved.

A further particularly suitable process is the extruder granulation. Suitable for extruder granulation are preferably basket extruders, radial extruders or dome extruders with low compaction of the granules. For granulation, a mixture of solids is, in a suitable mixer, made into a paste using a granulation liquid, until an extrudable material is formed. This is extruded in one of the extruders mentioned. For extrusion, hole sizes between 0.3 and 3 mm (preferably 0.5-1.5 mm) are used. Mixtures of active compounds, formulation auxiliaries and, if appropriate, water-soluble salts serve as mixtures of solids. These are generally pre-ground. In some cases, it is sufficient to pre-grind only the water-insoluble substances in suitable mills. Suitable granulation liquids are water, the APG according to the invention or aqueous solutions thereof. Also suitable are aqueous solutions of inorganic salts, nonionic surfactants, anionic surfactants, solutions of binders, such as polyvinylpyrrolidone, polyvinyl alcohol, carboxymethylcellulose, starch, vinylpyrrolidine/vinyl acetate copolymers, sugars, dextrin or polyethylene glycol. After the extruder granulation, the granules obtained are dried and, if appropriate, sieved to remove particles which are too coarse or too fine.

The resulting granules are dust-free, free-flowing, non-caking products which are readily soluble or dispersible in cold water.

The solid formulations according to the invention generally comprise from 0.01 to 95% by weight, preferably from 0.1 to 90% by weight, particularly preferably from 20 to 80% by weight and in particular from 30 to 70% by weight of the calcium salt of phosphorous acid. Here, it is preferably employed in a purity of 90% to 100%, preferably from 95% to 100%.

The solid formulation generally has the following composition:
20-80% by weight of the calcium salt of phosphorous acid
1-40% by weight of fungicide and optionally other pesticides
0.5-60% by weight of surfactants
   further auxiliaries ad 100% by weight.

Preference is given to the following composition:
20-80% by weight of the calcium salt of phosphorous acid
1-40% by weight of fungicide and optionally other pesticides
5-30% by weight of lignosulfonic acid or a salt thereof
5-30% by weight of a condensate of naphthalenesulfonic acids with phenol and formaldehyde
   further auxiliaries ad 100% by weight.

Particular preference is given to the following composition:
30-70% by weight of the calcium salt of phosphorous acid
3-30% by weight of fungicide and optionally other pesticides
5-20% by weight of lignosulfonic acid or a salt thereof
10-25% by weight of a condensate of naphthalenesulfonic acids with phenol and formaldehyde
0-5% by weight of a further surfactant
0-6% by weight of a water-soluble salt
0-5% by weight of solid carriers
   further auxiliaries ad 100% by weight.

In one embodiment of the compositions mentioned in an exemplary manner above, the solid formulation comprises, as active compounds, only fungicides, in another embodiment it additionally comprises other pesticides. In a further embodiment of the compositions mentioned in an exemplary manner above, the solid formulation comprises, as calcium salt of phosphorous acid, calcium hydrogenphosphite.

The invention also relates to a method for controlling phytopathogenic harmful fungi, wherein a composition comprising a synergistically effective amount of a calcium salt of phosphorous acid and a fungicide is applied to the plants, the seeds or the soil. Preferably, the composition is a solid formulation according to the invention.

For treating plant propagation materials, in particular seed, use is usually made of dusts (DS), water-dispersible powders and water-soluble powders (WS, SS). These formulations can be applied to the propagation materials, in particular seed, in undiluted form or, preferably, in diluted form. Here, the formulation in question can be diluted by a factor from 2 to 10, so that from 0.01 to 60% by weight, preferably from 0.1 to 40% by weight, of active compound is present in the formulations used for the dressing. Application can be carried out prior to sowing. The treatment of plant propagation material, in particular the treatment of seed, is known to the person skilled in the art and is carried out by dusting, coating or pelleting of the plant propagation material, the treatment preferably being carried out by pelleting, coating and dusting, such that, for example, premature germination of the seed is prevented.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetting agent, tackifier, dispersant or emulsifier. However, it is also possible to prepare concentrates composed of active substance, wetting agent, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%. The active compounds may also be used successfully in the ultra-low-volume (ULV) process, it being possible thereby to apply formulations comprising more than 95% by weight of active compound, or even to apply the active compound without additives.

Oils of various types, wetting agents, adjuvants, herbicides, bactericides, other fungicides and/or pesticides may be added to the active compounds or the compositions comprising them, if appropriate even immediately prior to the application (tank mix). These compositions may be added to the compositions according to the invention in a weight ratio of from 1:100 to 100:1, preferably from 1:10 to 10:1. Suitable adjuvants in this sense are in particular: organically modified polysiloxanes, for example Break Thru S 240®; alcohol alkoxylates, for example Atplus® 245, Atplus® MBA 1303, Plurafac® LF 300 and Lutensol® ON 30; EO/PO block polymers, for example Pluronic® RPE 2035 and Genapol® B; alcohol ethoxylates, for example Lutensol® XP 80; and sodium dioctylsulfosuccinate, for example Leophen® RA.

When used in crop protection, the application rates are from 0.01 to 2.0 kg of active compound per ha, depending on the desired effect. When used for treating plant propagation materials, for example seed, the amounts of active compounds used are generally from 1 to 2000 g/100 kg, preferably from 5 to 100 g/100 kg, of propagation material or seed.

The combinations according to the invention of calcium hydrogenphosphite with at least one fungicide and the formulations comprising them are advantageously suitable for controlling harmful fungi. They have excellent activity against a broad spectrum of phytopathogenic fungi including soil-borne pathogens originating in particular from the classes of the Plasmodiophoromycetes, Peronosporomycetes (syn. Oomycetes), Chytridiomycetes, Zygomycetes, Ascomycetes, Basidiomycetes and Deuteromycetes (syn. Fungi imperfecta). Some of them are systemically active and can be used in crop protection as foliar fungicides, as fungicides for seed dressing and as soil fungicides. In addition, they are suitable for controlling fungi which, inter alia, attack the wood or the roots of plants.

They are of particular importance for controlling a large number of pathogenic fungi on various crop plants such as cereals, for example wheat, rye, barley, triticale, oats or rice; beets, for example sugar beets or fodder beets; pomaceous fruits, stone fruits and soft fruits, for example apples, pears, plums, peaches, almonds, cherries, strawberries, raspberries, currants or gooseberries; leguminous plants, for example beans, lentils, peas, lucerne or soybeans; oil plants, for example oilseed rape, mustard, olives, sunflowers, coconut, cocoa, castor beans, oil palms, peanuts or soybeans; cucurbits, for example pumpkins, cucumbers or melons; fiber plants, for example cotton, flax, hemp or jute; citrus fruits, for example oranges, lemons, grapefruits or mandarins; vegetable plants, for example spinach, lettuce, asparagus, cabbage plants, carrots, onions, tomatoes, potatoes, pumpkins or bell peppers; laurel plants, for example avocados, cinnamon or camphor; energy and raw-material plants, for example corn, soybeans, wheat, oilseed rape, sugar cane or oil palms; corn; tobacco; nuts; coffee; tea; bananas; grapevines (grapes for eating and grapes for winemaking); hops; grass, for example lawns; rubber plants; ornamental and forest plants, for example flowers, shrubs, deciduous trees and coniferous trees, and also on the propagation material, for example seeds, and on the harvested material of these plants.

Preferably, they are used for controlling a large number of fungal pathogens in agricultural crops, for example potatoes, sugar beet, tobacco, wheat, rye, barley, oats, rice, corn, cotton, soybeans, oilseed rape, leguminous plants, sunflowers, coffee or sugar cane; fruit, grapevines and ornamental plants and vegetable plants, for example cucumbers, tomatoes, beans and pumpkins, and also on the propagation material, for example seeds, and the harvested material of these plants.

The term “plant propagation materials” includes all generative parts of the plant, for example seeds, and vegetative plant parts, such as the seedlings and tubers (for example potatoes) which can be utilized for propagating a plant. These include seeds, roots, fruits, tubers, bulbs, rhizomes, shoots and other plant parts including seedlings and young plants which are transplanted after germination or after emergence. The young plants can be protected by partial or complete treatment, for example by immersion or watering, against the harmful fungi.

Preferably, the treatment of plant propagation materials with the combinations of calcium hydrogenphosphite and at least one fungicide and the formulations comprising them is used for controlling a large number of fungal pathogens in cereal crops, for example wheat, rye, barley or oats; rice, corn, cotton and soybeans.

The term “crop plants” includes plants which have been modified by breeding, mutagenesis or genetic engineering. Genetically modified plants are plants whose genetic material has been modified in a manner which does not occur under natural conditions by crossing, mutations or natural recombination (i.e. reassembly of the genetic information). Here, in general, one or more genes are integrated into the genetic material of the plant to improve the properties of the plant.

Accordingly, the term “crop plants” includes plants which, by breeding and genetic engineering, have acquired tolerance to certain classes of herbicides, such as hydroxyphenylpyruvate dioxygenase (HPPD) inhibitors, acetolactate synthase (ALS) inhibitors, such as, for example, sulfonylureas (EP-A-0257993, U.S. Pat. No. 5,013,659) or imidazolinones (see, for example, U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073), enolpyruvylshikimate 3-phosphate synthase (EPSPS) inhibitors, such as, for example, glyphosate (see, for example, WO 92/00377), glutamine synthetase (GS) inhibitors, such as, for example, glufosinate (see, for example, EP-A-0242236, EP-A-242246), or oxynil herbicides (see, for example, U.S. Pat. No. 5,559,024).

Numerous crop plants, for example Clearfield® oilseed rape, tolerant to imidazolinones, for example imazamox, have been generated with the aid of classic breeding methods (mutagenesis). Crop plants such as soybeans, cotton, corn, beet and oilseed rape, resistant to glyphosate or glufosinate, which are available under the tradenames RoundupReady® (glyphosate) and Liberty Link® (glufosinate) have been generated with the aid of genetic engineering methods.

Accordingly, the term “crop plants” also includes plants which, owing to interventions by genetic engineering, produce one or more toxins, for example those of the bacterial strain Bacillus. Toxins which are produced by such genetically modified plants include, for example, insecticidal proteins of Bacillus spp., in particular B. thuringiensis, such as the endotoxins Cry1Ab, Cry1Ac, Cry1F, Cry1Fa2, Cry2Ab, Cry3A, Cry3Bb1, Cry9c, Cry34Ab1 or Cry35Ab1; or vegetative insecticidal proteins (VIPs), for example VIP1, VIP2, VIP3, or VIP3A; insecticidal proteins of nematode-colonizing bacteria, for example Photorhabdus spp. or Xenorhabdus spp.; toxins of animal organisms, for example wasp, spider or scorpion toxins; fungal toxins, for example from Streptomycetes; plant lectins, for example from peas or barley; agglutinins; proteinase inhibitors, for example trypsin inhibitors, serine protease inhibitors, patatin, cystatin or papain inhibitors, ribosome-inactivating proteins (RIPs), for example ricin, corn-RIP, abrin, luffin, saporin or bryodin; steroid-metabolizing enzymes, for example 3-hydroxysteroid oxidase, ecdysteroid-IDP glycosyl transferase, cholesterol oxidase, ecdyson inhibitors, or HMG-CoA reductase; ion channel blockers, for example inhibitors of sodium channels or calcium channels; juvenile hormone esterase; receptors of the diuretic hormone (helicokinin receptors); stilbene synthase, bibenzyl synthase, chitinases and glucanases. In the plants, these toxins may also be produced as pretoxins, hybrid proteins or truncated or otherwise modified proteins. Hybrid proteins are characterized by a novel combination of different protein domains (see, for example, WO 2002/015701). Further examples of such toxins or genetically modified plants which produce these toxins are disclosed in EP-A 374 753, WO 93/007278, WO 95/34656, EP-A 427 529, EP-A 451 878, WO 03/018810 and WO 03/052073. The methods for producing these genetically modified plants are known to the person skilled in the art and disclosed, for example, in the publications mentioned above. Numerous of the toxins mentioned above bestow, upon the plants by which they are produced, tolerance to pests from all taxonomic classes of arthropods, in particular to beetles (Coeleropta), dipterans (Diptera) and butterflies (Lepidoptera) and to nematodes (Nematoda).

Genetically modified plants which produce one or more genes coding for insecticidal toxins are described, for example, in the publications mentioned above, and some of them are commercially available, such as, for example, YieldGard® (corn varieties producing the toxin Cry1Ab), YieldGard® Plus (corn varieties which produce the toxins Cry1Ab and Cry3Bb1), Starlink® (corn varieties which produce the toxin Cry9c), Herculex® RW (corn varieties which produce the toxins Cry34Ab1, Cry35Ab1 and the enzyme phosphinothricin-N-acetyltransferase [PAT]); NuCOTN® 33B (cotton varieties which produce the toxin Cry1Ac), Bollgard® I (cotton varieties which produce the toxin Cry1Ac), Bollgard® II (cotton varieties which produce the toxins Cry1Ac and Cry2Ab2); VIPCOT® (cotton varieties which produce a VIP toxin); NewLeaf® (potato varieties which produce the toxin Cry3A); Bt-Xtra®, NatureGard®, KnockOut®, BiteGard®, Protecta®, Bt11 (for example Agrisure® CB) and Bt176 from Syngenta Seeds SAS, France (corn varieties which produce the toxin Cry1Ab and the PAT enzyme), MIR604 from Syngenta Seeds SAS, France (corn varieties which produce a modified version of the toxin Cry3A, see WO 03/018810), MON 863 from Monsanto Europe S.A., Belgium (corn varieties which produce the toxin Cry3Bb1), IPC 531 from Monsanto Europe S.A., Belgium (cotton varieties which produce a modified version of the toxin Cry1Ac) and 1507 from Pioneer Overseas Corporation, Belgium (corn varieties which produce the toxin Cry1F and the PAT enzyme).

Accordingly, the term “crop plants” also includes plants which, with the aid of genetic engineering, produce one or more proteins which are more robust or have increased resistance to bacterial, viral or fungal pathogens, such as, for example, pathogenesis-related proteins (PR proteins, see EP-A 0 392 225), resistance proteins (for example potato varieties producing two resistance genes against Phytophthora infestans from the wild Mexican potato Solanum bulbocastanum) or T4 lysozyme (for example potato cultivars which, by producing this protein, are resistant to bacteria such as Erwinia amylvora).

Accordingly, the term “crop plants” also includes plants whose productivity has been improved with the aid of genetic engineering methods, for example by enhancing the potential yield (for example biomass, grain yield, starch, oil or protein content), tolerance to drought, salt or other limiting environmental factors or resistance to pests and fungal, bacterial and viral pathogens. The term “crop plants” also includes plants whose ingredients have been modified with the aid of genetic engineering methods in particular for improving human or animal diet, for example by oil plants producing health-promoting long-chain omega 3 fatty acids or monounsaturated omega 9 fatty acids (for example Nexera® oilseed rape). The term “crop plants” also includes plants which have been modified with the aid of genetic engineering methods for improving the production of raw materials, for example by increasing the amylopectin content of potatoes (Amflora® potato).

As used herein, the term “protein” also includes oligopeptides, polypeptides or molecules prepared from polypeptides expressly also incorporating pre-proteins, hybrid proteins, peptides, truncated or otherwise modified proteins, including those resulting from posttranslational modifications, such as acylation (for example acetylation: addition of an acetyl group, usually at the N-terminus of a protein), alkylation, the addition of an alkyl group (for example addition of ethyl or methyl, usually at lysine or arginine residues) or demethylation, amidation at the C-terminus, biotinylation (acylation of conserved lysine residues with a biotin group), formylation, vitamin K-dependent γ-carboxylation, glutamylation (covalent binding of glutamate residues), glycosylation (binding of a glycosyl group to asparagine, hydroxylysine, serine or threonine with formation of glycoproteins), glycation (non-enzymatic glycosylation), glycylation (covalent binding of one or more glycine residues), covalent addition of a haem group, hydroxylation, iodination, isoprenylation (addition of an isoprenoid group, such as farnesol and geranylgeraniol), lipoylation (addition of a lipoate group) including prenylation, GPI anchor formation (for example myristoylation, farnesylation and geranylgeranylation), covalent binding of nucleotides or derivatives thereof including ADP ribosylation and addition of flavine, oxidation, pegylation, covalent binding of phosphatidyl inositol, phosphopantetheinylation (transfer of a 4′-phosphopantetheinyl radical from coenzyme A), phosphorylation (addition of a phosphate group, usually to serine, tyrosine, threonine or histidine), pyroglutamate formation, racemization of proline residues, tRNA-mediated addition of amino acids, such as arginylation, sulfatation (addition of a sulfate group to a tyrosine residue), selenoylation (cotranslational incorporation of selenium into selenoproteins), ISGylation (covalent binding to the ISG15 protein [Interferon-stimulated gene 15]), SUMOylation (covalent binding to the SUMO protein [‘small ubiquitin-related modifier’]), ubiquitination (covalent binding to the protein ubiquitin or poly-ubiquitin), citrullination or deimination (conversion of arginine into citrullin), deamidation (conversion of glutamine into glutamate or of asparagine into aspartate), formation of disulfide bridges (covalent binding of two cysteine residues) or proteolytic cleavage (cleavage of a protein at a peptide bond).

The combination of calcium hydrogenphosphite and at least one fungicide and the formulations comprising them are suitable especially for controlling the following plant diseases:
Albugo spp. (white rust) on ornamental plants, vegetable crops (for example A. candida) and sunflowers (for example A. tragopogonis);
Alternaria spp. (black spot) on vegetables, oilseed rape (for example A. brassicola or A. brassicae), sugar beet (for example A. tenuis), fruit, rice, soybeans and also on potatoes (for example A. solani or A. alternata) and tomatoes (for example A. solani or A. alternata) and Alternaria spp. (black spot) on wheat;
Aphanomyces spp. on sugar beet and vegetables;
Ascochyta spp. on cereals and vegetables, for example A. tritici (leaf spot) on wheat and A. hordei on barley;
Bipolaris and Drechslera spp. (teleomorph: Cochliobolus spp.) on corn (for example D. maydis), cereals (for example B. sorokiniana: brown leaf spot, spot blotch), rice (for example B. oryzae) and lawn;
Blumeria (before: Erysiphe) graminis (powdery mildew) on cereals (for example wheat or barley);
Botryosphaeria spp. (black dead arm disease) on grapevines (for example B. obtusa);
Botrytis cinerea (teleomorph: Botryotinia fuckeliana: gray mold) on soft fruit and pomaceous fruit (inter alia strawberries), vegetables (inter alia lettuce, carrots, celeriac and cabbage), oilseed rape, flowers, grapevines, forest crops and wheat (ear mold);
Bremia lactucae (downy mildew) on lettuce;
Ceratocystis (syn. Ophiostoma) spp. (blue stain) on deciduous trees and coniferous trees, for example C. ulmi (Dutch elm disease) on elms;
Cercospora spp. (Cercospora leaf spot) on corn, rice, sugar beet (for example C. beticola), sugar cane, vegetables, coffee, soybeans (for example C. sojina or C. kikuchii) and rice;
Cladosporium spp. on tomatoes (for example C. fulvum: tomato leaf mold, velvet leaf spot) and cereals, for example C. herbarum (black head mold, sooty mold) on wheat;
Claviceps purpurea (ergot) on cereals;
Cochliobolus (anamorph: Helminthosporium or Bipolaris) spp. (leaf blotch, spot blotch) on corn (for example C. carbonum), cereals (for example C. sativus, anamorph: B. sorokiniana: brown leaf spot, spot blotch) and rice (for example C. miyabeanus, anamorph: H. oryzae);
Colletotrichum (teleomorph: Glomerella) spp. (leaf blight, anthracnose) on cotton (for example C. gossypii), corn (for example C. graminicola: stalk rot and leaf blight), soft fruit, potatoes (for example C. coccodes: wilt), beans (for example C. lindemuthianum) and soybeans (for example C. truncatum);
Corticium spp., for example C. sasakii (sheath blight) on rice;
Corynespora cassiicola (leaf spot) on soybeans and ornamental plants;
Cycloconium spp., for example C. oleaginum on olives;
Cylindrocarpon spp. (for example fruit tree canker or grapevine decline, teleomorph: Nectria or Neonectria spp.) on fruit trees, grapevines (for example C. liriodendri, teleomorph: Neonectria liriodendri, black foot disease) and many ornamental trees;
Dematophora (teleomorph: Rosellinia) necatrix (white root rot/stem rot) on soybeans;
Diaporthe spp. for example D. phaseolorum (stem canker) on soybeans;
Drechslera (syn. Helminthosporium, teleomorph: Pyrenophora) spp. on corn, cereals, such as barley (for example D. teres, net blotch) and on wheat (for example D. tritici-repentis: tan spot), rice and lawn;
Esca disease (grapevine decline, apoplexy) on grapevines caused by Formitiporia (syn. Phellinus) punctata, F. mediterranea, Phaeomoniella chlamydospora (before Phaeoacremonium chlamydosporum), Phaeoacremonium aleophilum and/or Botryosphaeria obtusa;
Elsinoe spp. on pomaceous (E. pyri) and soft fruit (E. veneta: anthracnose, cane spot) and also grapevines (E. ampelina: anthracnose, birds-eye rot);
Entyloma oryzae (leaf smut) on rice;
Epicoccum spp. (black head mold, sooty mold) on wheat;
Erysiphe spp. (powdery mildew) on sugar beet (E. betae), vegetables (for example E. pisi), such as cucumber (for example E. cichoracearum) and cabbage plants, such as oilseed rape (for example E. cruciferarum);
Eutypa lata (eutypa canker or dieback, anamorph: Cytosporina lata, syn. Libertella blepharis) on fruit trees, grapevines and many ornamental trees;
Exserohilum (syn. Helminthosporium) spp. on corn (for example E. turcicum);
Fusarium (teleomorph: Gibberella) spp. (wilt, root and stem rot) on various plants, such as, for example, F. graminearum or F. culmorum (root rot and head blight or ear blight) on cereals (for example wheat or barley), F.-oxysporum on tomatoes, F. solani on soybeans and F. verticillioides on corn;
Gaeumannomyces graminis (take-all, black root rot) on cereals (for example wheat or barley) and corn;
Gibberella spp. on cereals (for example G. zeae) and rice (for example G. fujikuroi: bakanae disease);
Glomerella cingulata on grapevines, pomaceous fruit and other plants and G. gossypii on cotton;
grain staining complex on rice;
Guignardia bidwellii (black rot) on grapevines;
Gymnosporangium spp. on Rosaceae and juniper, for example G. sabinae (juniper-pear rust) on pears;
Helminthosporium spp. (syn. Drechslera, teleomorph: Cochliobolus) on corn, cereals and rice;
Hemileia spp., for example Hemileia vastatrix (coffee leaf rust) on coffee;
Isariopsis clavispora (syn. Cladosporium vitis) on grapevines;
Macrophomina phaseolina (syn. phaseoli) (root/stem rot) on soybeans and cotton;
Microdochium (Syn. Fusarium) nivale (snow mold) on cereals (for example wheat or barley);
Microsphaera diffusa (powdery mildew) on soybeans;
Monilinia spp., for example M. laxa, M. fructicola and M. fructigena (blossom blight) on stone fruit and other Rosaceae;
Mycosphaerella spp. on cereals, bananas, soft fruit and peanuts, such as, for example, M. graminicola (anamorph: Septoria tritici, septoria leaf blotch) on wheat or M. fijiensis (black sigatoka disease, black leaf streak) on bananas;
Peronospora spp. (downy mildew) on cabbage (for example P. brassicae), oilseed rape (for example P. parasitica), bulbous plants (for example P. destructor), tobacco (P. tabacina) and soybeans (for example P. manshurica);
Phakopsora pachyrhizi and P. meibomiae (soybean rust) on soybeans;
Phialophora spp., for example on grapevines (for example P. tracheiphila and P. tetraspora) and soybeans (for example P. gregata: stem disease);
Phoma lingam (root and stem rot) on oilseed rape and cabbage and P. betae (leaf spot) on sugar beet;
Phomopsis spp. on sunflowers, grapevines (for example P. viticola: cane and leaf spot) and soybeans (for example stem canker and pod and stem blight: P. phaseoli, teleomorph: Diaporthe phaseolorum);
Physoderma maydis (brown spot disease) on corn;
Phytophthora spp. (wilt, root, leaf, stem and fruit rot) on various plants, such as bell peppers and cucumber plants (for example P. capsici), soybeans (for example P. megasperma, syn. P. sojae), potatoes and tomatoes (for example P. infestans: late blight) and deciduous trees (for example P. ramorum: sudden oak death);
Plasmodiophora brassicae (club root disease) on cabbage, oilseed rape, raddish and other plants;
Plasmopara spp., for example P. viticola (peronospora of grapevines, downy mildew) on grapevines and P. halstedii on sunflowers;
Podosphaera spp. (powdery mildew) on Rosaceae, hops, pomaceous fruit and soft fruit, for example P. leucotricha on apples;
Polymyxa spp., for example on cereals, such as barley and wheat (P. graminis) and sugarbeet (P. betae) and the viral diseases transmitted thereby;
Pseudocercosporella herpotrichoides (eye spot disease, stem break, teleomorph: Tapesia yallundae) on cereals, for example wheat or barley;
Pseudoperonospora (downy mildew) on various plants, for example P. cubensis on cucumber plants or P. humili on hops;
Pseudopezicula tracheiphila (red fire disease, anamorph: Phialophora) on grapevines;
Puccinia spp. (rust) on various plants, for example P. triticina (brown rust of wheat), P. striiformis (stripe rust), P. hordei (dwarf leaf rust), P. graminis (stem rust, black rust) or P. recondita (brown rust of rye) on cereals, such as, for example, wheat, barley or rye, and on asparagus (for example P. asparagi);
Pyrenophora (anamorph: Drechslera) tritici-repentis (tan spot) on wheat or P. teres (net blotch) on barley;
Pyricularia spp., for example P. oryzae (teleomorph: Magnaporthe grisea, rice blast) on rice and P. grisea on lawn and cereals;
Pythium spp. (damping-off) on lawn, rice, corn, wheat, cotton, oilseed rape, sunflowers, sugar beet, vegetables and other plants (for example P. ultimum or P. aphanidermatum);
Ramularia spp., for example R. collo-cygni (leaf spot disease/physiological leaf spots) on barley and R. beticola on sugar beet;
Rhizoctonia spp. on cotton, rice, potatoes, lawn, corn, oilseed rape, potatoes, sugar beet, vegetables and on various other plants, for example R. solani (root/stem rot) on soybeans, R. solani (sheath blight) on rice or R. cerealis (sharp eye spot) on wheat or barley;
Rhizopus stolonifer (soft rot) on strawberries, carrots, cabbage, grapevines and tomatoes;
Rhynchosporium secalis (scald) on barley, rye and triticale;
Sarocladium oryzae and S. attenuatum (sheath rot) on rice;
Sclerotinia spp. (stem rot or white mold) on vegetable and agricultural crops, such as oilseed rape, sunflowers (for example Sclerotinia sclerotiorum) and soybeans (for example S. rolfsii);
Septoria spp. on various plants, for example S. glycines (brown spot) on soybeans, S. tritici (septoria leaf blotch) on wheat and S. (syn. Stagonospora) nodorum (leaf and glume blotch) on cereals;
Uncinula (syn. Erysiphe) necator (powdery mildew, anamorph: Oidium tuckeri) on grapevines;
Setosphaeria spp. (leaf blight) on corn (for example S. turcicum, syn. Helminthosporium turcicum) and lawn;
Sphacelotheca spp. (smut) on corn, (for example S. reiliana: head smut), millet and sugar cane;
Sphaerotheca fuliginea (powdery mildew) on cucumber plants;
Spongospora subterranea (powdery scab) on potatoes and viral diseases transmitted thereby;
Stagonospora spp. on cereals, for example S. nodorum (leaf and glume blotch, teleomorph: Leptosphaeria [syn. Phaeosphaeria] nodorum) on wheat;
Synchytrium endobioticum on potatoes (potato wart disease);
Taphrina spp., for example T. deformans (leaf curl) on peach and T. pruni (pocket plum) on plums;
Thielaviopsis spp. (black root rot) on tobacco, pomaceous fruit, vegetable crops, soybeans and cotton, for example T. basicola (syn. Chalara elegans);
Tilletia spp. (common or stinking bunt) on cereals, such as, for example, T. tritici (syn. T. caries, common bunt of wheat) and T. controversa (dwarf bunt) on wheat;
Typhula incarnata (gray snow mold) on barley or wheat;
Urocystis spp., for example U. occulta (stripe smut) on rye;
Uromyces spp. (rust) on vegetable plants, such as beans (for example U. appendiculatus, syn. U. phaseoli) and sugar beet (for example U. betae);
Ustilago spp. (smut) on cereals (for example U. nuda and U. avaenae), corn (for example U. maydis: corn smut) and sugar cane;
Venturia spp. (scab) on apples (for example V. inaequalis) and pears; and
Verticillium spp. (wilt of leaves and shoots) on various plants, such as fruit trees and ornamental trees, grapevines, soft fruit, vegetable and agricultural crops, such as, for example, V. dahliae on strawberries, oilseed rape, potatoes and tomatoes.

The combinations of calcium salts of phosphorous acid and at least one further fungicide and the formulations comprising them are furthermore suitable for controlling harmful fungi in the protection of materials and buildings (for example wood, paper, paint dispersions, fibers or tissues) and in the protection of stored products. In the protection of wood and buildings, particular attention is paid to the following harmful fungi: Ascomycetes, such as Ophiostoma spp., Ceratocystis spp., Aureobasidium pullulans, Sclerophoma spp., Chaetomium spp., Humicola spp., Petriella spp., Trichurus spp.; Basidiomycetes, such as Coniophora spp., Coriolus spp., Gloeophyllum spp., Lentinus spp., Pleurotus spp., Poria spp., Serpula spp. and Tyromyces spp., Deuteromycetes, such as Aspergillus spp., Cladosporium spp., Penicillium spp., Trichoderma spp., Alternaria spp., Paecilomyces spp. and Zygomycetes, such as Mucor spp., and in addition in the protection of materials the following yeast fungi: Candida spp. and Saccharomyces cerevisae.

Calcium salts of phosphorous acid are applied in the form of a composition with at least one fungicide by treating the harmful fungi, their habitat or the plants or plant propagation materials, for example seeds, the soil, areas, materials or spaces to be protected against fungal attack with a fungicidally effective amount of the compounds I. The application can be carried out both before and after infection of the plants, plant propagation materials, for example seeds, the soil, the areas, materials or spaces by the fungi. The application of calcium salts of phosphorous acid and fungicides can be carried out simultaneously or in succession.

Plant propagation materials can be treated prophylactically during or even before sowing or during or even before transplanting with calcium hydrogenphosphite or a calcium hydrogenphosphite-comprising composition.

The term “effective amount” means an amount of the agrochemical composition or of the compound I which is sufficient for controlling harmful fungi on crop plants or in the protection of materials and buildings and does not cause any significant damage to the treated crop plants. Such an amount may vary within a wide range and is influenced by numerous factors, such as, for example, the harmful fungus to be controlled, the respective crop plant or materials treated, the climatic conditions and compounds.

The examples below serve to illustrate the embodiments of the invention.

### EXAMPLES

Chemicals
Phosphoric esters of a fatty alcohol alkoxylate, acid number about 145 mg of KOH/g, pH about 2 (5% by weight in water), commercially available, for example, as Lutensit® A-EP from BASF SE.
Sodium salt of a naphthalenesulfonic acid/formaldehyde condensate, pulverulent, active content about 78% by weight, sodium sulfate content about 17% by weight, commercially available, for example, as Tamol® NH 7519, BASF SE.
Sodium lignosulfonate, CAS No. 8061-51-6, commercially available, for example, as Ufoxane® 3A (pulverulent sodium lignosulfonate from fermented and fractionated pine wood sulfite liquor, pH about 8.7) or as Borresperse® NA, Borregaard Lignotech.
Sodium diisobutylnaphthalenesulfonate, commercially available, for example, as Nekal® BX, BASF SE.
2-Ethylhexylglucoside, active compound content 65% by weight, 35% by weight water, commercially available, for example, as AG 6202, Akzo Nobel.
Sodium lauryl sulfate, commercially available, for example, as Agnique® SLS 90 P, Cognis.
Antifoam: silicone-containing aqueous emulsion, commercially available, for example, as Silfoam® SRE, Wacker.
Dithianon: suspension concentrate comprising 500 g/l of dithianon, commercially available, for example, as Delan® 500 SC from BASF SE.
Fungicide A: 5-ethyl-6-octyl-[1,2,4]triazolo[1,5-a]pyrimidin-7-ylamine (obtainable according to WO 2005/087773, WO 2007/012598 or WO 2008/087182).

Methods:

Unless indicated otherwise, the tests were carried out in planta under controlled greenhouse conditions. Temperature, atmospheric humidity and light conditions in the greenhouse chambers were adapted to the particular requirements of the host plants and pathogens. The visually determined values for the percentage of infected leaf areas were converted into efficacy as % of the untreated control. According to the Abbott formula, the efficacy (W) is calculated as follows: W=(1−a/b)*100.
a=corresponds to the fungal infection of the treated plants in % and
b=corresponds to the fungal infection of the untreated (control) plants in %.
   At an efficacy of 0 percent, the infection of the treated plants corresponds to that of the untreated control plants; at an efficacy of 100 percent the treated plants have no infection.

The expected efficacies of the combinations were determined according to Colby (Colby, S. R. “Calculating synergistic and antagonistic responses or herbicide combinations”, Weeds 15:20-22, 1967) and compared to the observed efficacies. Colby's formula: E=x+y−x*y/100
E=expected efficacy, expressed in % of the untreated control, when using the mixture of the active compounds A and B at the concentrations a and b
x=the efficacy, expressed in % of the untreated control, when using the active compound A at the concentration a
y=the efficacy, expressed in % of the untreated control, when using the active compound B at the concentration b

### Example 1

### Preparation of Calcium Hydrogenphosphite* Hydrate [Ca(H₂PO₃)₂.H₂0]

22.6 g of calcium hydroxide Ca(OH)₂ were added slowly to a solution of 50 g of H₃PO₃ in 100 ml of water. The resulting milky suspension was dried in a vacuum drying cabinet at 60° C. This gave 67 g of calcium hydrogenphosphite hydrate.

### Example 2a

### Preparation of Calcium Hydrogenphosphite* Hydrate Granules

67 g of calcium hydrogenphosphite* hydrate (from example 1) were initially charged in 200 ml of water, and 15 g of sodium lignosulfonate, 15 g of naphthalenesulfonic acid/formaldehyde condensate and 3 g of a phosphoric ester of a fatty alcohol alkoxide were added. The suspension was ground using a bead mill and subjected to fluidized-bed granulation at a temperature of 60° C. This gives a WG formulation having an active compound content of 67%. The pH of a 1% strength mixture with water is 3.9.

### Example 2b

### Preparation of Calcium Hydrogenphosphite* Hydrate Granules

50 g of calcium hydrogenphosphite* hydrate (from example 1) were initially charged in 200 ml of water, and 26 g of sodium lignosulfonate, 13 g of naphthalenesulfonic acid/formaldehyde condensate and 10 g of ammonium sulfate were added. The suspension was ground using a bead mill and subjected to fluidized-bed granulation at a temperature of 60° C. This gives a WG formulation having an active compound content of 50%. The pH of a 1% strength mixture with water is 3.9.

### Example 2c

### Preparation of Calcium Hydrogenphosphite* Hydrate Granules

46 g of calcium hydrogenphosphite* hydrate were initially charged in 200 ml of water, and 30 g of sodium lignosulfonate, 13 g of naphthalenesulfonic acid/formaldehyde condensate, 10 g of ammonium sulfate and 1 g of antifoam were added. The suspension was ground using a bead mill and subjected to fluidized-bed granulation at a temperature of 60° C. This gives a WG formulation having an active compound content of 46%.

### Example 3a-w

### Preparation of Active Compound-Comprising Granules (Table 1)

One or more active compounds and calcium hydrogenphosphite* hydrate (from example 1) were initially charged in 200 ml of water, and sodium lignosulfonate, naphthalenesulfonic acid/formaldehyde condensate and further formulation auxiliaries were added. The suspension was ground using a bead mill and subjected to fluidized-bed granulation at a temperature of 60° C. This gave WG formulations. The pH of the in each case 1% strength solution of the formulation in water was determined. The amounts of materials employed and the data for experiments a to w are shown in table 1 below.

### Example 4

### Dithianon and Ca(H₂PO₃) Against Late Blight on Tomatoes

A spray liquor comprising dithianon and calcium hydrogenphosphite (from example 2c) was prepared by diluting Delan® (dithianon suspension concentrate) and a formulation of calcium hydrogenphosphite granules with deionized water.

In a greenhouse, leaves of potted plants of the cultivar ‘big beef tomato St. Pierre’ were sprayed to runoff point with an aqueous suspension having the active component concentration stated below. After 5 days, the leaves were infected with a cold aqueous zoospore suspension of Phytophthora infestans having a density of 0.25*10⁶ spores/ml. The plants were then placed in a water vapor-saturated chamber at temperatures between 10° and 20° C. After 6 days, the late blight on the untreated but infected control plants had developed to such an extent that the infection could be determined visually in % (Table 2). In this test, the efficacy calculated according to Abbott of the mixture is greater than the efficacy calculated according to Colby; accordingly, a synergistic fungicidal activity is present.

TABLE 2

| | Active | Concentration in the | Efficacy | Expected efficacy |
|---|---|---|---|---|
| | compound | spray liquor (ppm) | W (%) | Colby (%) |
| A | dithianon (I) | 300 | 31 | — |
| B | Ca(H₂PO₃)₂ (II) | 750 | 13 | — |
| C | I + II | 300 + 750 | 60 | 41 |

### Example 5

### Fungicide A and Ca(H₂PO₃) Against Late Blight on Tomatoes

A spray liquor comprising dithianon and calcium hydrogenphosphite (from example 2c) was prepared by diluting a solution of fungicide A in DMSO and a formulation of calcium hydrogenphosphite granules with deionized water.

In a greenhouse, leaves of potted plants of the cultivar ‘big beef tomato St. Pierre’ were sprayed to runoff point with an aqueous suspension having the active compound concentration stated below. After 7 days, the leaves were infected with a cold aqueous zoospore suspension of Phytophthora infestans at a density of 0.25*10⁶ spores/ml, and the further procedure was as in example 4. In this test, the efficacy calculated according to Abbott of the mixture is greater than the efficacy calculated according to Colby; accordingly, a synergistic fungicidal activity is present (Table 3).

TABLE 3

| | Active | Concentration in the | Efficacy | Expected efficacy |
|---|---|---|---|---|
| | compound | spray liquor (ppm) | W (%) | Colby (%) |
| A | fungicide A (I) | 50 | 39 | — |
| B | Ca(H₂PO₃)₂ (II) | 750 | 0 | — |
| C | I + II | 50 + 750 | 44 | 39 |

### Example 6

### Pyraclostrobin and Ca(H₂PO₃) Against Downy Mildew on Grapevines

A spray liquor comprising pyraclostrobin and calcium hydrogenphosphite (from example 2c) was prepared by diluting a solution of pyraclostrobin in DMSO and a formulation of calcium hydrogenphosphite granules with deionized water.

Leaves of potted grapevines of the cultivar ‘Riesling’ were sprayed to runoff point with an aqueous suspension having the active compound concentration stated below. After the spray coating had dried on, the plants were placed in a greenhouse for 1 day. Only then were the leaves inoculated with an aqueous zoospore suspension of Plasmopara viticola. The grapevines were then initially placed in a water vapor-saturated chamber at 24° C. for 48 hours and then in a greenhouse at temperatures between 20 and 30° C. for 5 days. After this time, the plants were again placed in a humid chamber for 16 hours to promote sporangiophore eruption. The extent of the development of the infection on the undersides of the leaves was then determined visually. In this test, the efficacy calculated according to Abbott of both mixtures is greater than the efficacy calculated according to Colby; accordingly, in each case a synergistic fungicidal action is present (Table 4).

TABLE 4

| | Active | Concentration in the | Efficacy | Expected efficacy |
|---|---|---|---|---|
| | compound | spray liquor (ppm) | W (%) | Colby (%) |
| A | pyraclostrobin (I) | 0.5 | 92 | — |
| B | Ca(H₂PO₃)₂ (II) | 50 | 3 | — |
| C | I + II | 0.5 + 50 | 95 | 92 |

### Example 7

### Dithianon and Ca(H₂PO₃) Against Downy Mildew on Grapevines

A spray liquor comprising dithianon and calcium hydrogenphosphite (from example 2c) was prepared by diluting a solution of dithianon in DMSO and a formulation of calcium hydrogenphosphite granules with deionized water. The test was carried out as in example 6. In this test, the efficacy calculated according to Abbott of both mixtures is greater than the efficacy calculated according to Colby; accordingly, in each case a synergistic fungicidal action is present (Table 5).

TABLE 5

| | Active | Concentration in the | Efficacy | Expected efficacy |
|---|---|---|---|---|
| | compound | spray liquor (ppm) | W (%) | Colby (%) |
| A | dithianon (I) | 10 | 62 | — |
| B | Ca(H₂PO₃)₂ (II) | 50 | 3 | — |
| C | I + II | 10 + 50 | 87 | 63 |

### Example 8

### Dithianon and Ca(H₂PO₃)₂ Against Downy Mildew on Grapevines

The spray liquor from example 7 was used. This test entailed a certain application pattern where the leaf area applied consisted only of a small rectangle in the form of a bar. Here, a bar form having a section of a height of 1.5 cm and a width of 7 cm was found to be expedient. The application described is carried out on the lower half of the upper side of the leaf. After the spray coating had dried on, the plants were placed in a greenhouse for 1 day. Only then were the undersides of the leaves inoculated with an aqueous zoospore suspension of Plasmopara viticola. The grapevines were then initially placed in a water vapor-saturated chamber at 24° C. for 48 hours and then in a greenhouse at temperatures between 20 and 30° C. for 5 days. After this time, the plants were again placed in a humid chamber for 16 hours to promote sporangiophore eruptions. The extent of the development of the infection on the apical half of the underside of the leaf was then determined visually. In this test, the efficacy calculated according to Abbott of both mixtures is greater than the efficacy calculated according to Colby; accordingly, in each case a synergistic fungicidal action is present (Table 6).

TABLE 6

| | Active | Concentration in the | Efficacy | Expected efficacy |
|---|---|---|---|---|
| | compound | spray liquor (ppm) | W (%) | Colby (%) |
| A | dithianon (I) | 10 | 6 | — |
| B | Ca(H₂PO₃)₂ (II) | 50 | 0 | — |
| C | I + II | 10 + 50 | 18 | 6 |

### Example 9

### Fungicide A and Ca(H₂PO₃) Against Downy Mildew on Grapevines (Translaminar Action)

The spray liquor was prepared according to example 5 and adjusted to the active compound concentration mentioned in Table 7. The test was carried out as in example 8; however, the active compounds were applied to the upper side of the leaf. To allow the active compound in question to be taken up by the grapevine leaves and, if appropriate, to be translocated, the application was carried out 48 hours prior to the inoculation with Plasmopara viticola. In this test, the efficacy calculated according to Abbott of the mixture is greater than the efficacy calculated according to Colby; accordingly, a synergistic fungicidal action is present (Table 7).

TABLE 7

| | Active | Concentration in the | Efficacy | Expected efficacy |
|---|---|---|---|---|
| | compound | spray liquor (ppm) | W (%) | Colby (%) |
| A | fungicide A (I) | 5 | 1 | — |
| B | Ca(H₂PO₃)₂ (II) | 100 | 0 | — |
| C | I + II | 5 + 100 | 15 | 1 |

### Example 10

### Fungicide A and Ca(H₂PO₃) Against Downy Mildew on Grapevines

A spray liquor comprising fungicide A and calcium hydrogenphosphite (from example 2c) was prepared according to example 5. The test was carried out as in example 6. However, after the spray coating had dried on, the plants were placed in a greenhouse for 7 days instead of one day. In this test, the efficacy calculated according to Abbott of both mixtures is greater than the efficacy calculated according to Colby; accordingly, in each case a synergistic fungicidal action is present (Table 8).

TABLE 8

| | Active | Concentration in the | Efficacy | Expected efficacy |
|---|---|---|---|---|
| | compound | spray liquor (ppm) | W (%) | Colby (%) |
| A | fungicide A (I) | 100 | 85 | — |
| B | Ca(H₂PO₃)₂ (II) | 750 | 9 | — |
| C | I + II | 100 + 750 | 92 | 86 |

### Example 11

### Boscalid and Ca(H₂PO₃) Against Phakopsora pachyrhizi on Soybeans

A spray liquor comprising boscalid and calcium hydrogenphosphite (from example 2c) was prepared by diluting a solution of boscalid in DMSO and a formulation of calcium hydrogenphosphite granules with deionized water. The tests with Phakopsora pachyrhizi were carried out on soybean plants (glycine max) of the cultivar ‘Monsoy’. The plants used were at the 2-leaf stage. The leaves were sprayed to runoff point with an aqueous suspension having the active compound concentration stated below. After 2 days, the treated leaves were inoculated with a uredospore suspension of soybean rust. The plants were then placed in a chamber with high atmospheric humidity (95-99%) at 20°-22° C. for 24 hours. During this time, the spores germinated and the germ tubes penetrated into the leaf tissue. The next day, the test plants were returned to the greenhouse and cultivated at temperatures between 23°-26° C. and 65 to 70% relative atmospheric humidity for 10-12 days. The extent of the rust fungus development on the leaves was then determined visually in %. In this test, the efficacy calculated according to Abbott of both mixtures is greater than the efficacy calculated according to Colby; accordingly, in each case a synergistic fungicidal action is present (Table 9).

TABLE 9

| | Active | Concentration in the | Efficacy | Expected efficacy |
|---|---|---|---|---|
| | compound | spray liquor (ppm) | W (%) | Colby (%) |
| A | boscalid (I) | 20 | 11 | — |
| B | Ca(H₂PO₃)₂ (II) | 1000 | 48 | — |
| C | I + II | 20 + 1000 | 79 | 54 |

### Example 12

### Dithianon and Ca(H₂PO₃) Against Downy Mildew on Grapevines

A spray liquor comprising dithianon and calcium hydrogenphosphite (from example 2c) was prepared by diluting a solution of dithianon in DMSO and a formulation of calcium hydrogenphosphite granules with tap water. The test was carried out at a test location in Rhineland Palatinate, Germany, outdoors using natural infections. The test was carried out with 4 repetitions using the GEP standard. In total, application was carried out on 9 dates using a spray interval of 14-16 days. The result scoring shown was carried out 1 day after the 6th application. The intensity of infection in % was scored visually on the leaves in accordance with EPPO guideline PP 1/31(3). In this test, the efficacy calculated according to Abbott of the mixture is greater than the efficacy calculated according to Colby; accordingly, a synergistic fungicidal activity is present (Table 10).

TABLE 10

| | Active | Concentration in the | Efficacy | Expected efficacy |
|---|---|---|---|---|
| | compound | spray liquor (ppm) | W (%) | Colby (%) |
| A | dithianon (I) | 300 | 85 | — |
| B | Ca(H₂PO₃)₂ (II) | 900 | 18 | — |
| C | I + II | 300 + 900 | 93 | 88 |

### Example 13

### Dithianon and Ca(H₂PO₃)₂ Against Downy Mildew on Grapevines

The test was carried out at a test location in Rhineland Palatinate, Germany, outdoors with natural infections, as described in example 12. Application was carried out on 7 dates in total at a spray interval of 14-16 days. In this test, the efficacy calculated according to Abbott of the mixture is greater than the efficacy calculated according to Colby; accordingly, a synergistic fungicidal action is present (Table 11).

TABLE 11

| | Active | Concentration in the | Efficacy | Expected efficacy |
|---|---|---|---|---|
| | compound | spray liquor (ppm) | W (%) | Colby (%) |
| A | dithianon (I) | 400 | 48 | — |
| B | Ca(H₂PO₃)₂ (II) | 1200 | 21 | — |
| C | I + II | 400 + 1200 | 76 | 59 |

### Example 14

### Dithianon and Ca(H₂PO₃)₂ Against Downy Mildew on Grapevines

The test was carried out at a test location in Rhineland Palatinate, Germany, outdoors with natural infections, as described in example 12. Application was carried out on 9 dates in total at a spray interval of 9-11 days. The scoring of the results shown was carried out 4 days after the 8th application. In this test, the efficacy calculated according to Abbott of the mixture is greater than the efficacy calculated according to Colby; accordingly, a synergistic fungicidal activity is present (Table 11).

TABLE 12

| | Active | Concentration in the | Efficacy | Expected efficacy |
|---|---|---|---|---|
| | compound | spray liquor (ppm) | W (%) | Colby (%) |
| A | dithianon (I) | 300 | 56 | — |
| B | Ca(H₂PO₃)₂ (II) | 900 | 24 | — |
| C | I + II | 300 + 900 | 76 | 67 |

TABLE 1

| | | | | | | | | Active | |
|---|---|---|---|---|---|---|---|---|---|
| | Ca hydrogen- | | Active | | | | | compound | |
| | phosphite from | | compound | Sulfonate ^{b)} | Sulfonic | Further formulation auxiliaries | | content ^{e}) | |
| | Ex. 1 [g] | Pesticide | [g] | [g] | acid ^{c)} [g] | [g] | | in WG [%] | pH |
| a | 67 | dimethomorph | 9 | 10 | 11 | 3 | Lutensit A-EP | 76 | 3.9 |
| b | 50.3 | dithianon | 12.5 | 10 | 24.2 | 3 | Lutensit A-EP | 62.8 | 4 |
| c | 44.7 | dithianon | 16.7 | 10 | 17.6 | 3 | Lutensit A-EP | 69.4 | 4.1 |
| | | active | 8 | | | | | | |
| | | compound 1 ^{a)} | | | | | | | |
| d | 44.7 | metiram | 27.5 | 10 | 14.8 | 3 | Lutensit A-EP | 72.2 | 4.1 |
| e | 40.3 | dithianon | 16 | 15 | 19.3 | 3 | Lutensit A-EP | 59.5 | 4.1 |
| | | pyraclostrobin | 3.2 | | | 3.2 | amorphous silicic acid | | |
| f | 44.7 | mancozeb | 27.5 | 10 | 14.8 | 3 | Lutensit A-EP | 72.2 | 4.0 |
| g | 44.7 | dimethomorph | 3 | 15 | 11.3 | 3 | Lutensit A-EP | 67.7 | 4.0 |
| | | mancozeb | 20 | | | 3 | ammonium sulfate | | |
| h | 50.3 | folpet | 20 | 10 | 18.7 | 1 | Agnique SLS 90 P | 69.7 | 4 |
| i | 50.3 | dimethomorph | 3.4 | 10 | 15.3 | 1 | Agnique SLS 90 P | 73.7 | 4.2 |
| | | folpet | 20 | | | | | | |
| j | 44.7 | dimethomorph | 7.5 | 10 | 17.3 | 3 | Nekal BX | 69.7 | 4.2 |
| | | dithianon | 17.5 | | | | | | |
| k | 63 | pyraclostrobin | 5 | 15 | 11 | 3 | AG 6202 | 68 | 4.1 |
| | | | | | | 3 | amorphous silicic acid | | |
| l | 50.3 | dithianon | 12.5 | 11 | 23.2 | 2 | Nekal BX | 62.8 | 4 |
| m | 44.7 | dithianon | 16.7 | 10 | 15.6 | 2 | AG 6202 | 69.4 | 4.0 |
| | | active | 8 | | | 3 | sodium sulfate | | |
| | | compound 1 ^{a)} | | | | | | | |
| n | 63 | pyraclostrobin | 5 | 15 | 13 | 1 | Agnique SLS 90 P | 68 | 4.1 |
| | | | | | | 3 | amorphous silicic acid | | |
| o | 63 | active | 8 | 10 | 18 | 1 | Agnique SLS 90 P | 71 | 4.1 |
| | | compound 1 ^{a)} | | | | | | | |
| p | 44.7 | dithianon | 16.7 | 10 | 16.6 | 1 | Agnique SLS 90 P | 69.4 | 4.0 |
| | | active | 8 | | | 3 | ammonium sulfate | | |
| | | compound 1 ^{a)} | | | | | | | |
| q | 50.3 | pyraclostrobin | 5 | 15 | 15.7 | 3 | Nekal BX | 63.3 | 4.2 |
| | | active | 8 | | | 3 | amorphous silicic acid | | |
| | | compound 1 ^{a)} | | | | | | | |
| r | 31.5 | metiram | 27.5 | 15 | 19.0 | 2 | Nekal BX | 61.5 | 4.1 |
| | | pyraclostrobin | 2.5 | | | 2.5 | amorphous silicic acid | | |
| s | 63 | kresoxim- | 10 | 10 | 13 | 1 | Agnique SLS 90 P | 73 | 4.1 |
| | | methyl | | | | 3 | ammonium sulfate | | |
| t | 63 | boscalid | 10 | 10 | 16 | 1 | Agnique SLS 90 P | 73 | 4.0 |
| u | 63 | active | 8 | 10 | 17 | 2 | AG 6202 | 71 | 4.1 |
| | | compound 1 ^{a)} | | | | | | | |
| v | 63 | pyrimethanil | 8 | 10 | 16 | 3 | AG 6202 | 71 | 4.1 |
| w | 44.7 | pyraclostrobin | 13.4 | 15 | 17.1 | 3 | Nekal BX | 61.5 | 4.2 |
| | | boscalid | 3.4 | | | 3.4 | amorphous silicic acid | | |

^{a)} fungicidally active compound 1: 5-ethyl-6-octyl-[1,2,4]triazolo[1,5-a]pyrimidin-7-ylamine;
^{b)} sodium lignosulfonate;
^{c)} naphthalenesulfonic acid/formaldehyde condensate;
^{d)} calculated sum of calcium hydrogenphosphite and active compound

1-16. (canceled)

17. A solid formulation for crop protection, comprising a calcium salt of phosphorous acid and a fungicide.

18. The solid formulation of claim 17, wherein the formulation is in the form of granules.

19. The solid formulation of claim 17, wherein the calcium salt of phosphorous acid comprises calcium hydrogenphosphite.

20. The solid formulation of claim 17, wherein the formulation comprises at most 25% by weight of solid carriers.

21. The solid formulation of claim 17, wherein the formulation comprises an aromatic sulfonic acid and/or a salt thereof.

22. The solid formulation of claim 17, wherein the formulation comprises a lignosulfonic acid or a salt thereof and also a condensate of naphthalenesulfonic acids with formaldehyde and/or phenol or a salt thereof.

23. A process for preparing a solid formulation comprising a calcium salt of phosphorous acid, wherein an aqueous composition comprising calcium salts of phosphorous acid is dried.

24. The process of claim 23, wherein the drying is carried out using a granulation process.

25. A process for preparing a calcium salt of phosphorous acid, wherein phosphorous acid H₃PO₃ is added to an aqueous suspension of calcium hydroxide Ca(OH)₂ and/or calcium oxide CaO.

26. A method for increasing the efficacy of a fungicide in agriculture comprising applying a calcium salt of phosphorous acid which comprises calcium hydrogenphosphite to a plant, plant propagation material, soil, areas, materials, or spaces.

27. The method of claim 26, wherein the fungicide comprises at least one fungicide from the group consisting of dithianon, pyraclostrobin, boscalid, 5-ethyl-6-octyl-[1,2,4]triazolo[1,5-a]pyrimidin-7-ylamine, dimethomorph, metiram, mancozeb, folpet and kresoxim-ethyl.

28. The method of claim 26, wherein the calcium salts of phosphorous acid are present in the form of a solid formulation.

29. The method of claim 26, wherein the fungicide is essentially free of copper salts.

30. A method for controlling phytopathogenic harmful fungi, wherein a composition comprising a synergistically effective amount of a calcium salt of phosphorous acid and a fungicide is applied to the plants, the seeds or the soil.

31. The method of claim 30, wherein the composition is a solid formulation comprising an aromatic sulfonic acid and/or a salt thereof.

32. A seed comprising the solid formulation of claim 21 in an amount of from 1 to 2000 g/100 kg.
